(19) United States
(12) Patent Application Publication
(10) Pub. No.: US 2003/0094141 A1
(43) Pub. Date: May 22, 2003

(54) Integrated system for shellfish production: encompassing hatchery, nursery, brood-stock conditioning and market conditioning phases; also water treatment, food supplement, propulsion, anchoring, security, and devices for the integration of neighborhood values and shellfish production.

(76) Inventor: Russell P. Davis, Virginia Beach, VA (US)

Correspondence Address: Russell Patton Davis, 613 Mango Dr., Virginia Beach, VA, 23432, US

(21) Appl. No.: 09/891,757

(22) Filed: Jun. 26, 2001

Related U.S. Application Data
(60) Provisional application No. 60/214,458, filed on Jun. 28, 2000.
(60) Provisional application No. 60/232,079, filed on Sep. 8, 2000.
(60) Provisional application No. 60/237,033, filed on Oct. 2, 2000.
(60) Provisional application No. 60/250,389, filed on Dec. 1, 2000.
(60) Provisional application No. 60/263,820, filed on Feb. 2, 2001.

(51) Int. Cl. A01K 61/00

(52) U.S. Cl. 119/234

(57) ABSTRACT

The invention (the process, its supporting devices, and applications) serves the endeavor of shellfish aquaculture. The invention improves and innovates: 1) tidally powered systems for raising shellfish seed, 2) grow-out, 3) brood stock conditioning, 4) market conditioning, & food supplement, 5) hatchery systems, 6) hatchery/nursery integration, resource sharing and optimization, ergonomics and economics, 7) water treatment, 8) Propulsion, 9) Anchorage, 10) Security, and 11) Devices for the Integration of Neighborhood Values and Shellfish Production. Such large increased economies of production suggest new uses for shellfish. Shellfish grow-out can provide cost effective and ecologically advantageous infrastructure benefits to eroding beaches, unstable channels, and water quality and the health of estuaries in general. The system is flexible in operation so that it may maximize the use of estuarine tidal energy and phytoplankton in order to maximize the ecological and economic benefits of the operation. The system is designed with particular attention to Virginia and Federal law so that permitting needs are minimized. Moreover the system is optimized to fit in well with the estuarine community and be a desirable, unobtrusive neighbor.

### BRIEF SUMMARY OF THE INVENTION

Shellfish aquaculture is a rapidly growing field that is increasingly constrained by the scarcity and cost of land based hatchery and nursery operations. The high capital and operating costs associated with these facilities along with their vulnerability to instances of low water quality and the scarcity of potential locations motivated the inception of this design. The strategies employed by this system have been borrowed from various species and the community interactions while the devices and processes to implement the strategies and integrate them into my political context are my own invention.

The need to be a good neighbor and to avoid noxious chemicals also drove the design. The water born nature of the invention means that traditional practices that rely on the “on the grid” services of fresh water, sewer, and power were not sustainable or appropriate. Moreover the environmental and economic cost of those practices are not essential and are largely avoided in this design. The “pared to the essence” approach has the additional benefit of establishing a new and higher standard of “best practice” and environmental sensitivity. The political and permitting requirements are fearsome and capricious as it is. Relying on traditional aseptic practices could invite well-meaning but disproportionate criticism that may be avoided by adopting a higher standard of excellence. Adopting ordinary practices would also require more capital that I could muster and would make the proposition much riskier relative to the reward.

The light-weight, low profile, construction and the fine tuned integration of hatchery and nursery operations dramatically reduce the startup and operating costs of the shellfish operation.

The combination of features presented in this patent is of such economic impact that this design is apt to influence all future shellfish operations. Unless great strides are made in expanding the market for shellfish it is likely this invention will cause a glut in the shellfish market.

This potential glut can best be addressed by promoting the ecological benefits of shellfish culture. The local water quality effects of such infrastructure uses of shellfish culture can have a dramatic benefit to subaquatic vegetation, general environmental vitality, and improved fishing—particularly the surf fishing that is of particular interest to the tourist serving community. Sufficient shellfish culture can even change our estuarine sediments from the blue, sub-oxic, iron sulfide sediments that are dominant today into orange-yellow, calcium carbonate/iron hydroxide-carbonate sediment that is declared to be geologically ordinary by the bluffs of the James and York Rivers, cobbles at Cape Henry and by posthole digger excavations under some ancient oyster beds in Linkhorn Bay. I do have strong evidence, though not conclusive, that this change in sediment character is an essential factor in the diseases that decimate older, high spawn rate, oysters. This restoration of our estuaries will require requires a vastly larger market for shellfish if the restoration will not be killed by the affect its initial success has on shellfish prices. A marketing campaign build around “Save the Bay—Eat More Clams and Oysters” can be quite credible and is worthy of more that a festival or two.

Although hatchery production is sometimes reputed to be straight-forward failure appears common. These hatcheries are usually land based because of the current practices used to attempt aseptic conditions. The logistical, political, and capital requirements of such an operation are daunting and inhibit entry and production, and are such that the price of 1 mm hatchery produced shellfish nursery stock seems stable at about three thousand dollars per million. This patent removes much of that need to base hatcheries on land. By lowering the capital and operating costs of the hatchery, and by removing many of the political obstacles to establishing a hatchery, many more hatcheries may come into being.

Moreover that three thousand dollar per million seed cost (1 mm size) increases the capital requirements for entry into the nursery business. That high cost makes the reward/risk ratio of nursery operations much less. The possibilities of losing that large capital requirement makes businesspeople much less eager to accept the weather damage and theft risk associated with an estuary based nursery even though the risk to reward ratio is attractive over a long term. By lowering the cost of beginning nursery stock many more nurseries are apt to be started and a smaller proportion of those nurseries will be land based.

Moreover this patent lowers the capital and operating cost of hatcheries and nurseries and vastly expands the number of locations that are suitable for a hatchery/nursery operation.

One tidally powered floating upweller (FLUPSY) of this patent captures the tidal flow by means of a fabric scoop that is constructed so that it can touch bottom without damage or disruption of the operation. This design enables FLUPSYS to operate in shallow water which dramatically expands the number of suitable locations.

Another floating upwellers of this patent utilize a pivoted vane to capture the tidal flow so that the upweller body does not need to swing on its anchorage so that it may face the tide as required by other tidally powered upwellers.

The removal of anchorage swing makes the narrow, closed end, channels common to the large marshes and flats suitable for hatchery and nursery operations.

The narrow range of average current speeds required by prior tidally powered upweller nurseries has also put a severe limit on the number of suitable locations. This design, which emulates freshwater mussel reproduction, unbounds that constraint completely—Forward motion is an economical alternative when current is lacking.—At design time, changes in proportion adapt the floating upweller portion of the design to differing average currents.—In operation, high currents may be adapted to by only partial rotation of the direction control vane.

An upweller of this patent does not use the traditional one screen silo for nursery operations but uses adjustably spaced mesh frames top and bottom so that higher flow rates may be sustained without tumbling the seed which disrupts feeding. The multiple screens and increased nursery stock depth creates a higher pressure drop across the screen that does much to aid the even distribution of water flow. Flow rate and stocking density may be increased an order of magnitude. The mesh top and bottom lowers the vertical dimension reducing storage requirements. That adjustable dimension and higher flow velocities and stocking density reduces the number of seed containers needed and nearly eliminates the redundancy that is normal in the prior art.

In addition to achieving great reduction of both cost and risk, there is a resulting compactness of the operation is a great enabler of economies of scale. When scale is such that constant attention is warranted the risks of theft and weather damage are much reduced.

The overall design paradigm behind of this system is to create human implementable devices and processes that take the economies discovered and tested by evolution and apply them to the culture of shellfish. Two hatchery devices in this patent emulate the larviparous and glocidian reproduction strategies employed by freshwater pearly mussels. The marsupium of larvipaous shellfish is emulated by 1) a nested mesh box design and 2) a crenallated mesh box design. The Nursery devices in this patent generally emulate the glocidian reproduction strategy of the freshwater pearly mussel.

The portions of this invention that have not been “CLAIM”ed, or successfully “CLAIM”ed, but might have been are committed to the public domain in this patent disclosure so those features may not be made a “CLAIM” in future patents such that they would impair the value of this patent.

The public domain contributions of South Carolina Sea Grant in their publications on Tidal-Powered Upwelling Nursery and Hard Clam culture were pivotal to the development of this design. Their contributions are worthy of recognition and emulation. Their contributions are also incorporated into this disclosure by reference.

The public domain contributions of Harbor Branch Oceanographic Institution of Fort Pierce, Fla., as offered in their Bivalve Hatchery course are also appreciated and incorporated by reference.

Licensing terms for this patent are expected to be very friendly and community spirited. Nominal license fees will be based on production. Unburdensome covenant commitments to diversity in production and environmental service are likely. Email list server support of licensees is likely to be of great value. Licensees will receive a proforma operations log and model business plan. Patent infringement is apt to be much less rewarding than license.

Scholastic rigor is not an appropriate measure for judging this endeavor. The invention's problem solving accomplishments are a better measure and even that measure cannot be reasonable taken until the implementation has matured. In that the devices give broader application of a strategy proven successful by evolution, the designs are conceptually sound. I will grant that many of the described problem dynamics and their solutions are based upon unquantified sensory assessment—most all of the water chemistry dynamic was assessed by sight, taste, smell, and feel for viscosity and surface tension. Even so all the dynamics are likely to prove true. Some of the dynamics relied upon may prove to be significant in a smaller zone than hoped but the fossil evidence absolutely commands my enthusiasm. The scientific quantification of the effective bounds to my solution are not currently within my reach. There is no shame in this—just a necessary degree of immaturity. It would be a great lose to Virginia Beach and to the earth as a whole if its clams and oysters were not allowed to express their regard for the matured system of inventions. In that the core inventions apply the ‘proven-by-nature’ reproduction strategies it seems only natural that the strategies will prove to be effective and economic.

### CROSS-REFERENCE TO RELATED APPLICATIONS

None—Not Applicable

### STATEMENTS REGARDING FEDERAL SPONSORED RESEARCH

None—Not Applicable

### REFFERENCE TO MICROFICHE APPENDIX

None—Not Applicable

### BACKGROUND OF THE INVENTION—AKA

1. Field of the Invention

The invention, a system of processes, devices, and applications, serves the endeavor of shellfish aquaculture. The invention improves and innovates: 1) economical systems for raising shellfish seed, Grow-out, Depuration/Finishing and brood stock conditioning; 2) hatchery systems; 3) integration, resource sharing and optimization, ergonomics and economics, 4) water treatment, 5) Propulsion, 6) Anchoring, 7) Security and 8) Devices for the Integration of Neighborhood Values and Shellfish Production. Such increased economies of production beg for expanded application as presented in claims 18 and 19.

| | |
|---|---|
| U.S. Class: | 119/238; 119/239; 119/241; 119/236 |
| Intern'l | A01K 061/00 |
| Class: | |
| Field of | 119/4,241,239,240,238,236,234,208,223,242,243,244,205, |
| Search: | 204,207,209,205/688,701,742 204/DIG. 6, |
| | 210/198.1,199,205,206,138,139,140,143,104,743 |

2. Description of the Prior Art

In recent years, a number of innovative aquaculture systems have been developed. Three examples of such systems include U.S. Pat. No. 6,024,050 to Rheault, issued Feb. 8, 2000 and U.S. Pat. No. 5,438,958 to Ericsson et al., issued Aug. 8, 1995 and U.S. Pat. No. 4,860,690 to De Santo et al., issued Aug. 29, 1989; and. The disclosures of the Rheault, Ericsson et al. and De Santo et al. U.S. patents are hereby incorporated by reference as are the enabling methods that are customary to the industry and represented in a publication of the South Carolina Sea Grant, “A Manual for the culture of the Hard Clam Mercanaia spp in South Carolina”.

One significant drawback of the aquaculture system disclosed in De Santo et al. resides in its utilization of tidal-powered baskets (in lieu of upwellers) to rear the shellfish. Such baskets allow the waters in and around the marine dock to flow about the shellfish seed being grown but the flow rate of the water circulating there through is necessarily limited by the natural conditions of the ambient environment. This natural flow rate is typically far too inadequate to permit rapid growth in high concentrations of shellfish seed during the nursery phase. Thus, De Santo et al.'s aquaculture system is prone to either low concentrations of shellfish seed or to stunted shellfish growth.

One way to alleviate the deficiencies in the De Santo aquaculture system is to use aquaculture upwellers (as in Rheault) in lieu of De Santo's baskets. Upwellers typically consist of a silo formed from a hollow cylindrical piece of PVC pipe and a screen assembly permanently affixed (typically glued) to one end of the silo.

In the case of prior art floating upwellers, the upweller is partially suspended within a liquid ambient environment such that the screened end of the silo is disposed well below the surface of the liquid. Additionally, the opposite end of the silo extends well above the surface of the liquid and an exit port in the upweller permits water (and the nutrients disposed therein) to be pumped there through at an accelerated rate. A higher concentration of shellfish seed may, thus, be placed into an upweller without stunting shellfish growth. In Rheault's design and in common usage of upweller silos seed density is still flow rate limited because of the tumbling of nursery stock that occurs at higher velocities. Such tumbling disrupts feeding and inhibits growth and may inflict damage to the nursery stock. The tumbling is also accompanied by a destabilization of the flow where some spots on the screen experience ‘tunneling’ or ‘rat holing’ and have localized accelerated flow with an incumbent decrease in flow in the portion of the screen and seed mass not over the tunnel. The water passing through the ‘tunnel’ effectively bypasses the seed creating a great loss in effectiveness with respect to phytoplankton capture and shellfish growth.

The high exit port velocity of the upwellers of prior usage also prohibit the from being used in the hatchery for raising planktonic shellfish.

In design prior to this patent, still another deficiency associated with upwellers in prior usage is that a shellfish grower must stock far more upwellers than can be actually used at any given time. Shellfish seed growth is maximized when fluid flow through an upweller is maximized. Conventionally, very young seed are first raised in upwellers having relatively fine screens to permit some fluid passage while preventing the seed from falling through the pores in the screen assembly. As the shellfish seed grow, however, the seed must be transferred into upwellers having coarser screen assemblies to enhance the fluid flow through the upweller given the customary constraint on the power of the water flow. Thus, throughout the nursery phase of the shellfish life cycle, three or more sets of upwellers could be employed to retain the growing shellfish seed. The shellfish upwellers not being utilized at any given time must be stored. The relatively large space required increases costs associated with the aquaculture endeavor and inhibits the attainment of large economies of scale and drives up operating and maintenance costs.

These strategies involving the changing upweller silos were driven by the cost of pumping water and by the assumption that water flow was both fixed and limited resource and that the upwellers could not afford to be bear the resistance and pressure drop that would stabilize and effectively distribute the flow of water through the bed of shellfish much as in a “gravity table”, such as is used to separate empty hulls and stones from peanuts. Even with relatively large cross upweller pressure drops that would suppress ‘tunneling’, flow is constrained by need to avoid tumbling the shellfish seed which disrupts feeding and may damage the seed.

Removing flow and pressure drop constraints as achieved by this patent design allows for an increase in efficiency and capacity per investment dollar that exceeds an order of magnitude.

The weight and monolithic construction of prior art floating upwellers made periodic hauling obligatory. This is particularly true for existing tidally powered upwellers. The expense and inconvenience of this maintenance is apt to make maintenance untimely such that reduced efficiency and downtime are suffered—effective capacity is even smaller than the small apparent capacity.

Given this state of the art, it is not often that the economic strategies appropriate to large scale nurseries can be profitably adopted. Even constant management is not typically justified. This lack of attendance does much to raise the risk of theft and weather damage to floating systems. Also, in highly productive waters, biofouling is so fast that constant attention is required for success. The benefits of constant management make features that enable economies of scale very economically significant.

In the prior art, the economy and water-quality-security of floating upwellers has been inconveimoemt or unavailable, and that mobility was only available to the nursery portion of a shellfish operations—The design under this patent application fully extends that security hatchery as well as nursery operations. There is practically no prior art in this area except that displayed by the evolution of the freshwater pearly mussel and a few shellfish possessing a marsupium.

In the prior art, episodes of low water quality also act to diminish effective capacity. This patent addresses this issue with mobility and appropriate propulsion systems. There is practically no prior art in this area except that displayed by the evolution of the freshwater pearly mussels' glocidia strategy.

Some forms of low water quality as in the lack of calcium carbonate super-saturation are more pervasive, more insidious, and less obvious. This patent addresses this issue also and addresses saxitoxin dipuration, Vibrio dipuration and oxygen enrichment as incidental benefits.

In the prior art, hatchery operation has, to my knowledge, been entirely land based and/or has been constrained and defined by aseptic practices appropriate to a land base. The absence of normal bacterial flora has made traditional hatchery highly vulnerable to adverse bacterial blooms. The spawning practices of land based hatcheries also made them extremely vulnerable to malformed larvae due to polyspermy. This patent addresses these issues as well.

The high cost of seed resulting from the state of the prior art has severely constrained the production and customary uses for shellfish. The high capital and operating cost of this prior practice is addressed in this patent.

The prior high cost of seed and its relatively low abundance made predator exclusion (PE) net a requirement for successful shellfish growout opereations. The large reduction in seed cost and large increase in seed quantity made possible by this invention may even remove the PE net constraint and political liability. Given the anticipated change in the cost of seed shellfish Zostera roots may be grown as a substitute for predator exclusion net.

The scarcity and high cost of sites suitable for a shellfish hatchery and nursery operations has also severely constrained the advancement of the industry.

Uncertain shellfish taste, freshness, and safety of origin are major obstacles to market expansion and are major factors in the price of shellfish. Perceived regional differences in these qualities account for huge differences in price. This patent addresses the taste and freshness issue also. There is practically no prior art in this area.

Electronic Security and Observation Systems can mitigate the risk theft and weather damage also, but scale is needed to justify the investment and operation of these systems also. Improvements in communication like the internet, satellite and cellular offer opportunities. There is practically no prior art in this area.

The economy of production offered by the advances described in this patent open possibilities of new markets for shellfish that are based upon the ecological and economic benefits that shellfish can offer. These benefits are enhanced by developing the beneficial relationship between shellfish, seagrass, macroalgae and plankton. Cultural devices and practices to reap the economic benefit of these relationships are claimed. There is no visible prior art in this area. Devices to integrate shellfish production with community values and other ecosystem participants like sub-aquatic vegetation and shrimp are also claimed. There is practically no prior art in this area. The political difficulties that historically attended shellfish production may only be obviated by the extraordinary degree of neighborliness expressed in these devices.

U.S. Pat. Documents

| | | | |
|---|---|---|---|
| 1660259 | February 1928 | Elsworth | 119/4. |
| 2989945 | June 1961 | Ford | 119/4. |
| 3196833 | July 1965 | Glancy | 119/4. |
| 3495573 | February 1970 | Vanderborgh, Jr. et al. | 119/4. |
| 3650244 | March 1972 | Fordham | 119/4. |
| 3517648 | June 1970 | Budge | 119/236. |
| 3766888 | October 1973 | Wiegardt, Jr. | 119/240. |
| 3996894 | December 1976 | Wiegardt, Jr. | 119/4. |
| 3996895 | December 1976 | Wiegardt, Jr. | 119/4. |
| 4080930 | March 1978 | Pruder et al. | 119/4. |
| 4183322 | January 1980 | Shultz et al. | 119/4. |
| 4257351 | March 1981 | Scura et al. | 119/4. |
| 4320717 | March 1982 | Rowley | 119/241. |
| 4328764 | May 1982 | Nickel. | |
| 4344384 | August 1982 | Rowley | 119/241. |
| 4395970 | August 1983 | Kunkle et al. | 119/240. |
| 4434743 | March 1984 | Nickel. | |
| 4438725 | March 1984 | O'Sullivan et al. | 119/238. |
| 4532883 | August 1985 | Lockwood et al. | 119/4. |
| 4621588 | November 1986 | Harris. | |
| 4844015 | July 1989 | Garvey et al. | 119/4. |
| 4860690 | August 1989 | De Santo et al. | |
| 5269254 | December 1993 | Gagliano et al. | 119/237. |
| 5400745 | March 1995 | Saxby et al. | |
| 5438958 | August 1995 | Ericsson et al. | |
| 5660141 | August 1997 | Kjersem et al. | 119/223. |
| 5692455 | December 1997 | Wang | 119/242. |
| 6024050 | February 2000 | Rheault | 119/238 |
| 5543034 | August 1996 | Hilbertz, et al. | |
| 5395491 | March 1995 | Hasvold | 205/701 |
| WATER | | | |
| TREATMENT | | | |
| 5378374 | October 1993 | Andersen | 210/743 |
| 5458768 | October 1995 | Andersen | 210/104 |
| 5328574** | March 1993 | Mercier; Dominique | 204/149 |
| 5795459** | August 1998 | Sweeney | 205/701 |
| 4419206 | | Frame | |
| 1685300 | September 1928 | Travers | 210/724. |
| 1765424 | June 1930 | Hageman et al. | 210/724. |
| 3551332 | June 1969 | Baumann et al. | 210/724. |
| 4320012 | March 1982 | Palm et al. | 210/724. |
| 4427643 | January 1984 | Fowler | 210/743. |
| 4465597 | August 1984 | Herman et al. | 210/724. |
| 5112499 | May 1992 | Murray et al. | 210/724. |
| PROPULSION | | | |
| 5145428 | September 1992 | Harrison | 440/89 |
| 293777 | February 1884 | Pearsens | 416/223. |
| 909246 | January 1909 | Spear | 416/242. |
| 1023584 | April 1912 | Muhlberg | 416/242. |
| 4545771 | October 1985 | Iio | 440/89. |
| 4778419 | October 1988 | Bolle et al. | 440/89. |
| 4802872 | February 1989 | Stanton | 440/89. |
| SECURITY | | | |
| ALGAE | | | |
| 5,801,050 | Sep. 1, 1998 | Uchida, et al. | 435/257.1; |
| | | | 435/252.1; |
| | | | 435/259 |

### BRIEF DESCRIPTION OF SEVERAL VIEWS OF THE INVENTION

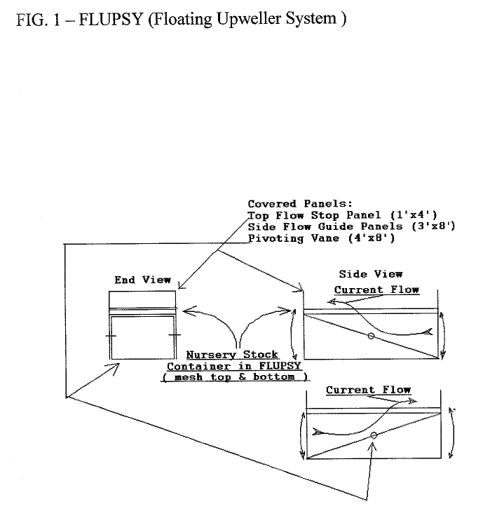

FIG. 1—FLUPSY (Floating Upweller System)

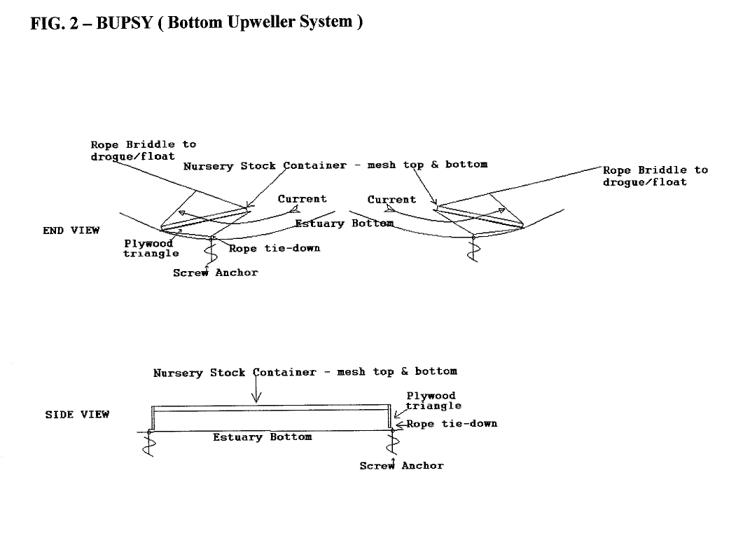

FIG. 2—BUPSY (Bottom Upweller System)

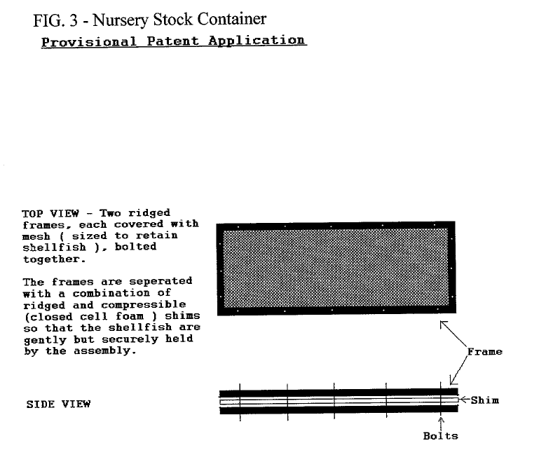

FIG. 3—Nursery Stock Container—Framed Mesh top and bottom with solid and compressible shims

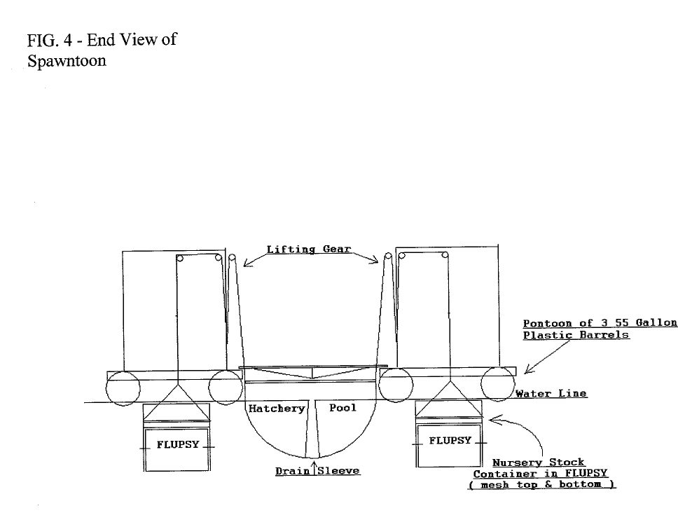

FIG. 4—End View of Spawn Toon with two FLUPSYs and two hatchery live wells

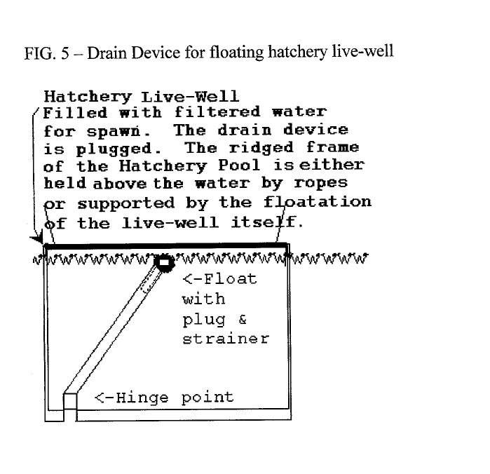

FIG. 5—Nursery Stock Container—Mesh envelope held in a frame

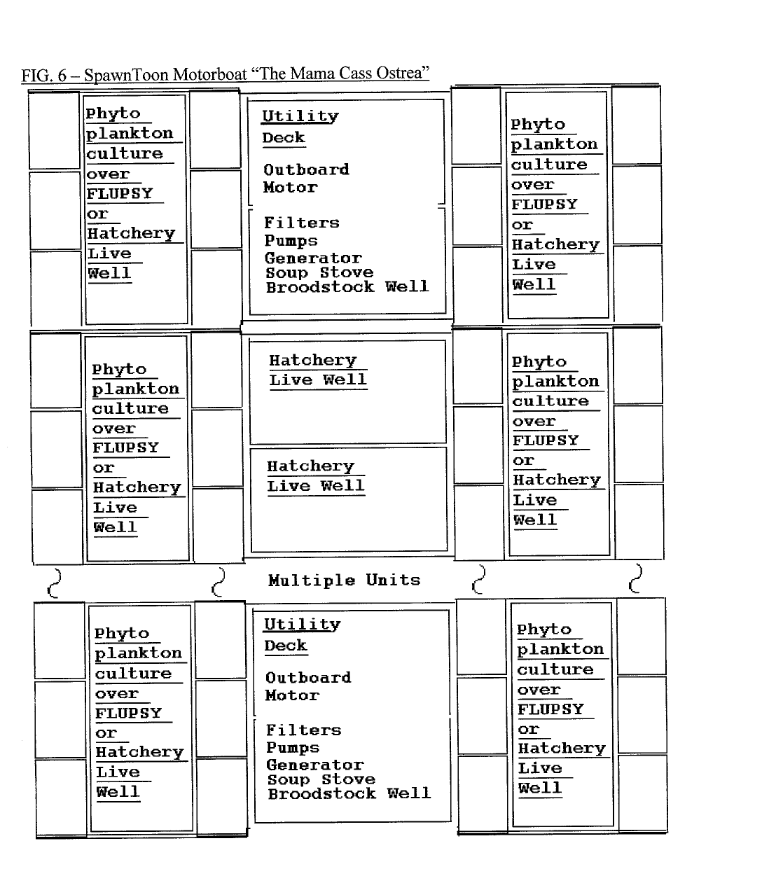

FIG. 6—Spawntoon Motorboat “Mama Cass Ostrea” Plan view with ellipsis to accommodate multiple segments.

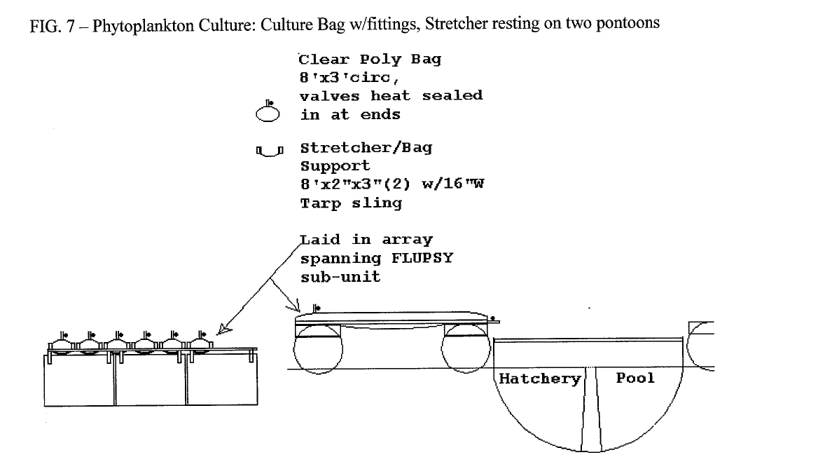

FIG. 7—Phytoplankton Culture: Culture Bag w/fittings, Stretcher on two pontoons

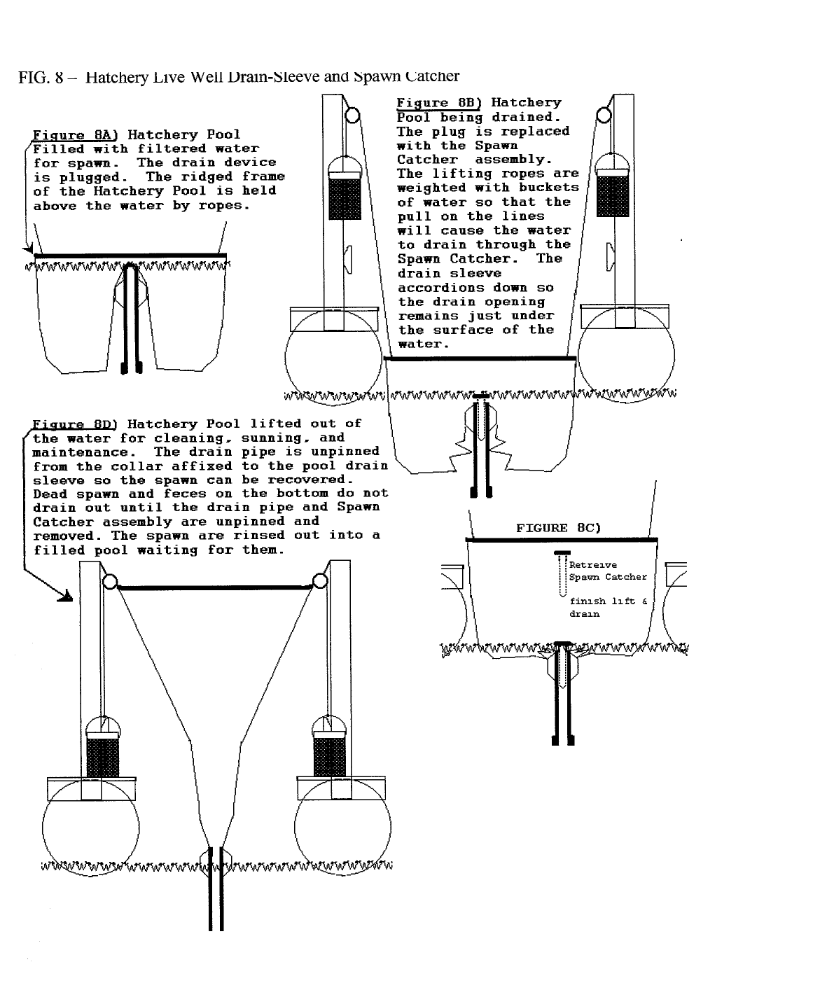

FIG. 8—Hatchery Live Well and Drain-Sleeve/Spawn Catcher design

FIG. 8A) Hatchery Live Well

Filled with filtered water for spawn.

The drain device is plugged.

The ridged frame of the Hatchery Live Well is held above the water by ropes, shock-cord and/or floatation in the rim.

FIG. 8B) Hatchery Live Well being drained. The plug is replaced with the Spawn Catcher assembly. The lifting ropes are weighted with buckets of water so that the pull on the lines will cause the water to drain through the Spawn Catcher. The drain sleeve accordions down so the drain opening remains just under the surface of the water.

FIG. 8C) Hatchery Live Well nearly drained. Dead spawn and feces on the bottom do not drain out until the Spawn Catcher assembly is removed. The spawn are rinsed out into a filled well waiting for them.

FIG. 8D) Hatchery Live Well lifted out of the water for cleaning, sunning, and maintenance.

FIG. 5) Hatchery Live Well and Inclinable Drain-Pipe/Spawn Catcher design

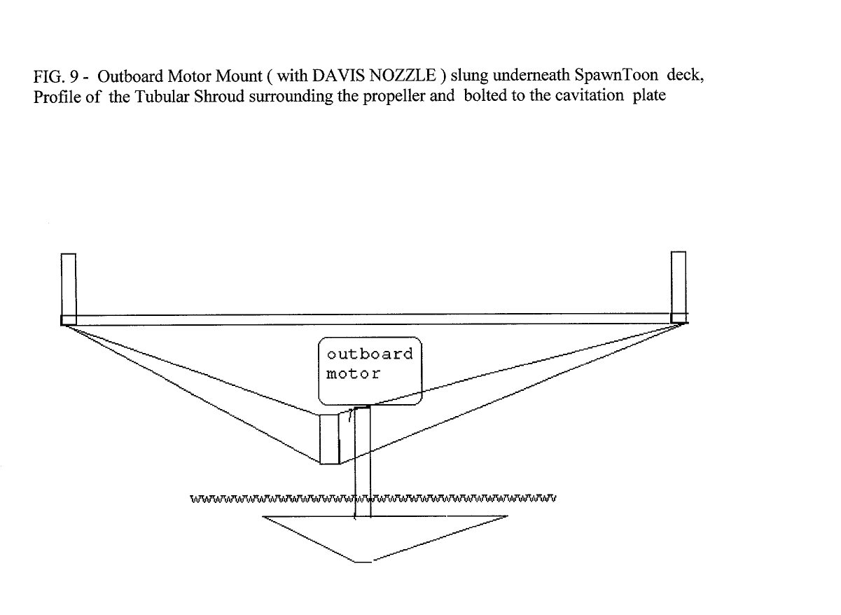

FIG. 9) Davis Propeller nozzle for cavitation and draft control, a variation on the Kort Nozzle

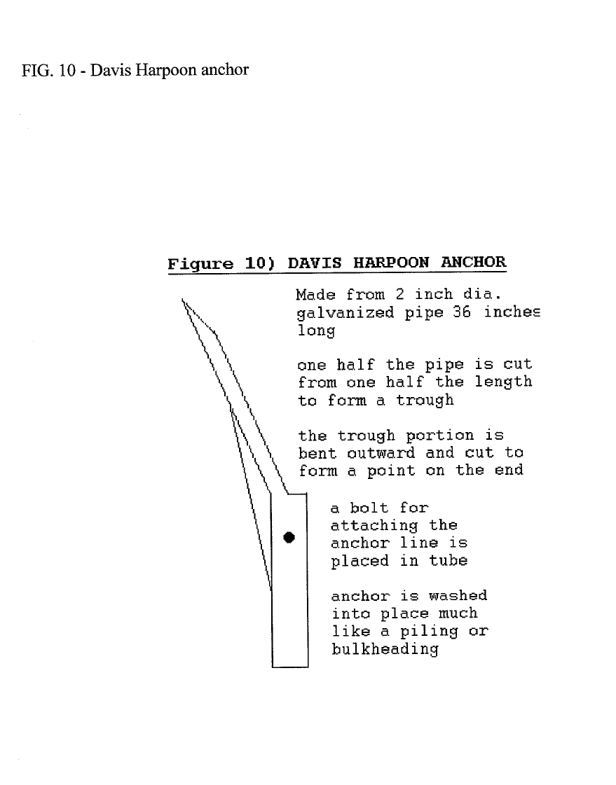

FIG. 10) Davis Harpoon Anchor—

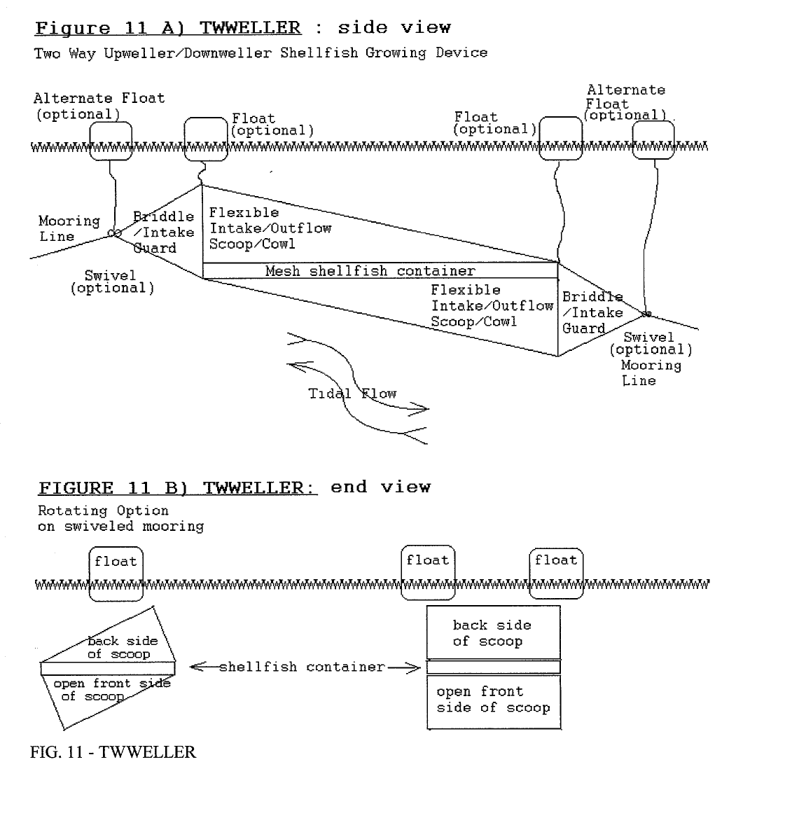

FIG. 11) TWWELLER (Two Way—upweller/downweller—shellfish growing device)

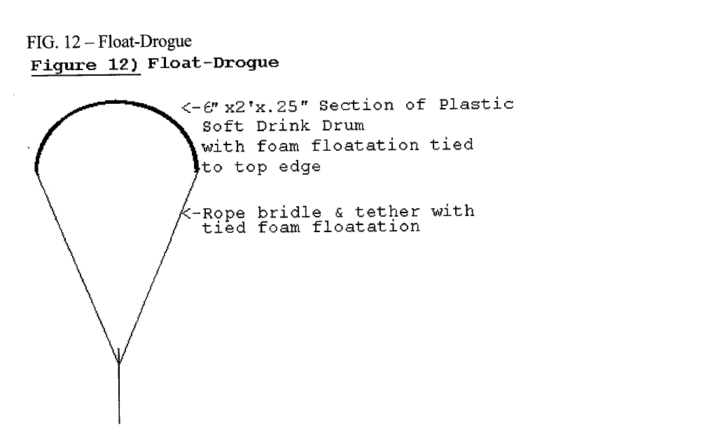

FIG. 12—Float-Drogue

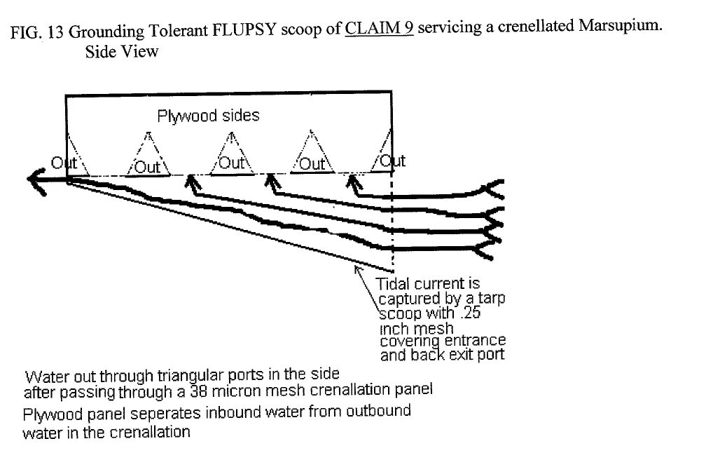

FIG. 13—Grounding Tolerant FLUPSY scoop of claim 9 servicing a crenellated Marsupium.

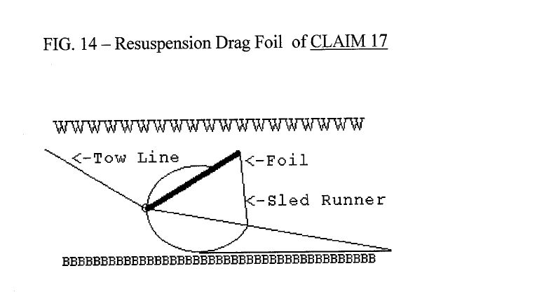

FIG. 14—Resuspension Drag Foil

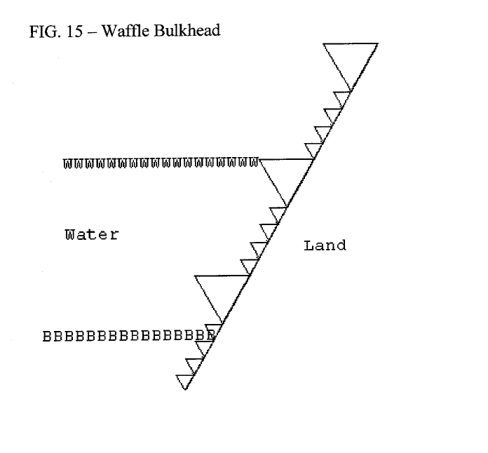

FIG. 15—Waffle Bulkhead of

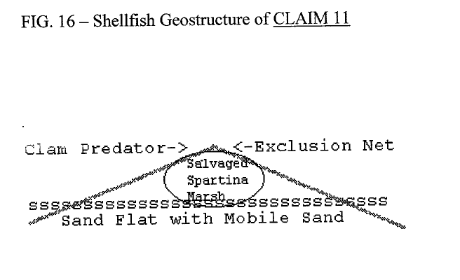

FIG. 16—Shellfish Geostructure of claim 11

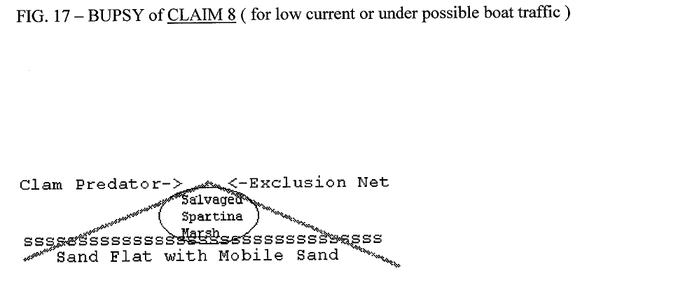

FIG. 17—BUPSY of claim 8 (low current or below channel)

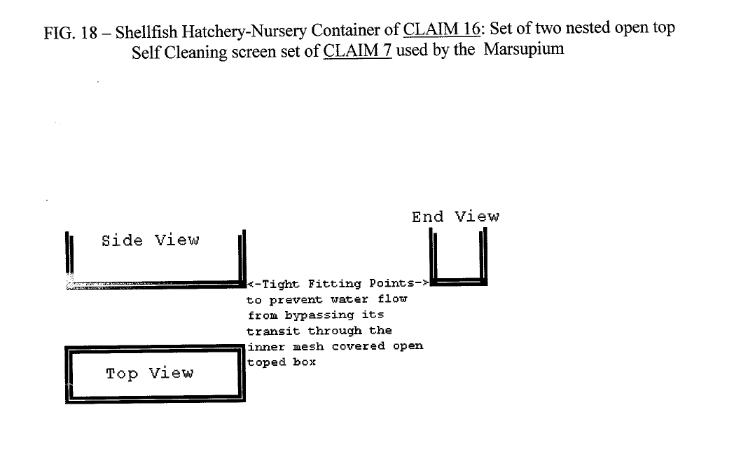

FIG. 18) Marsupium Spawn Container for FLUPSY—Set of Two Nested mesh-paneled open-top boxes Two screens containing shrimp and minnows that must clean the fine screen for their food. of claim 15

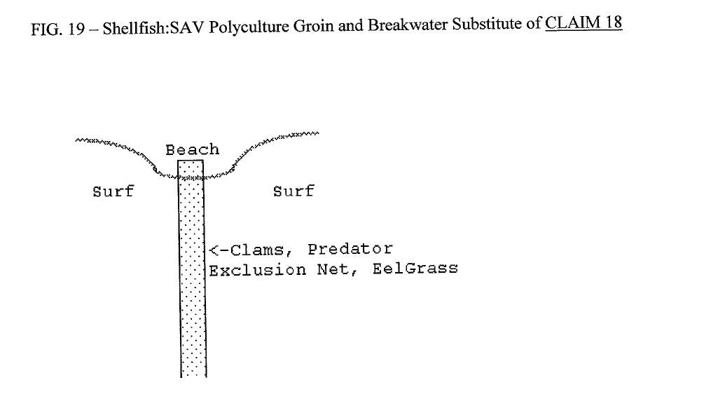

FIG. 19—Shellfish:SAV Polyculture Groin Substitute of claim 18

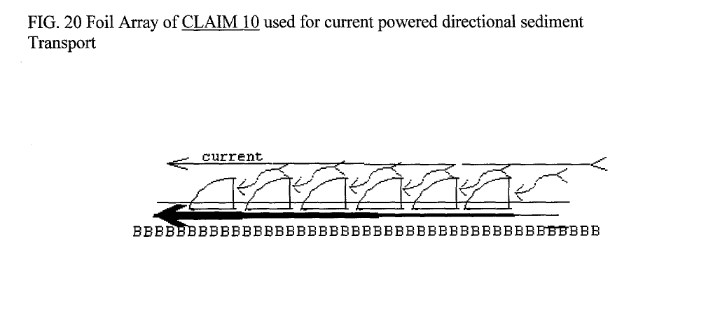

FIG. 20 Foil Array of claim 10 used for current powered directional sediment transport

### DETAILED DESCRIPTION OF THE INVENTION—

Description of the Preferred Embodiment

While the present invention is described in connection with what is presently considered to be the most practical and preferred embodiments, it is to be understood that the invention is not limited to the disclosed embodiments, but is intended to cover the various modifications and equivalent arrangements included within the spirit and scope of the claims.

Some of the innovations in this system of inventions are incremental improvements that require a narrow context for their value to be realized. Other innovations in this system of 56 inventions are paradigm shifts and order of magnitude improvements in the art of shellfish culture.

Perhaps these claims define the future of the shellfish industry. If such is the case it I will see that the ownership of those claims is not an obstacle to the industry. In part, these claims define ways in which the shellfish industry can be reconciled and even allied with both the environmental and real estate development interests in its community. Previous antagonisms are mostly bad economy, short-sighted, and merely the interim result of humanity's immaturity in playing the master-of-their-domain role.

The injustices resulting for that immaturity may be hard to bear at times but they are the fuel of evolution—At least they are in the context of this patent application which probably would not have come into being were it not for certain conceits, perjuries, VA§18.2-481(5) felonies, and physical assaults that have temporarily ‘poisoned-the-well’ of government in Virginia. Publishing by way of patent is one delightful alternative. That many of claim incumbent to this system of 56 inventions are nearly unenforceable is fine with me—so long as I am allowed to contribute to my community and be included in its prosperity. It is also fine with me that some of these claims have patent enforceability that can serve to protect my community from a ruinous glut in production—that is provided that I am not excluded from the encouragement and protection that is defined by the letter of Virginia law.

SHELLFISH CONTAINER #1—Used in Hatchery, Nursery, Brood-stock conditioning, dipuration/market finishing: (CLAIM 1) The four claimed tidally power shellfish growing devices, BUPSY (high current) model, vaned FLUPSY, grounding tolerant FLUPSY and a TWWELLER may utilize containers of this design.

The shellfish container has two mesh covered frames bound together and also spaced apart by a combination of shims (mesh, solid and/or compressible) such that the depth of the frame is adjustable to both accommodate the shellfish growth and snuggly hold the shellfish so they will not be jostled by high flows of water. The frames may also be opened for cleaning and size separation of the nursery stock.

The outer mesh is sized to retain the shellfish it will receive.

Additional inner mesh may be used to provide a matrix that helps maintain the distribution of the shellfish on the frame. As growth progresses layers of mesh are easily shed as a nestable frame holds each mesh.

The nursery stock shellfish is then loaded on the nested bottom set of screen frames and evenly spread.

The top frame is placed on the assembly and clamped so that the nursery stock is held loosely enough to allow for growth but tight enough to prevent tumbling in the current. Such jostling disrupts feeding and may damage the shellfish. This configuration allows for a much higher optimal flow and stocking rate which is of great economic advantage, perhaps a tenfold advantage given unlimited tidal current. The catenary of the mesh between the frame rims provides enough play to allow for considerable growth before the bolts need loosening. In highly productive, high flow waters, biofouling is so rapid that operation size and density must be such that every other day external brushing is justified during the summer. Biofouling may smother shellfish seed within one week.

After growth uses the reasonable limits of the catenary the frame assembly is disassembled and a compressible shim is inserted and the frame set is rebolted and the shim compressed.

To accommodate additional growth (beyond the reasonable limits of the catenary's expansion) the bolts are loosened and the compressible shim expands.

When the bolts have been so loosened as to risk a gap and the lose of shellfish, the frame is disassembled, a wooden shim is added, and the frame reassembled and made snug to the nursery stock in preparation for another round of growth and bolt loosening.

As growth progresses layers of mesh are easily shed as a nestable frame (made of 2″ by 2″ wood) holds each mesh.

A less expensive variation on this design is a frame of 1″×6″ boards screwed together so that it binds the edges of a mesh envelope together and binds the envelope in a plane to receive the flow through of water. These containers allow the clams to bunch up to they must be smaller in size and have a lower density of shellfish seed in order to work satisfactorily. This is a good design for lower current locations where the anchoring device may simply be two sand bags attached at the BUPSY pivot points on the frame.

Another variation is employed in FLUPSY hatchery operation. In this case the fine mesh is between 15 and 45 microns and the frames consist of two nesting open top boxes. The nested box frames mate snugly at their bottoms. The upwelling of water passes up through the bottom mesh of both boxes excluding shellfish larvae predators and competitors. The outer coarser mesh covered box frame accumulates the bulk of the fouling. That outer box frame is swapped out for cleaning every two days. The double layer of fine intake mesh insures a more evenly distributed flow of water across the bottom surface by its proportionally large contribution to the total resistance to flow the assembly. The water flows out through the sides of the nested mesh covered frames as is fitting with the FLUPSY design. The top is open for observation, handling and cleaning. The spawntoon hulls on port and starboard prevent waves from topping the container and contamination the contents with shellfish larvae predators and competitors. The natural supply of food is relied on to a large degree but additional food may be added during the two hours around every slack tide (eight hours per day).

VANED FLUPSY & WATER “SWEETENING” TREATMENT: This patent contains a floating tidally powered upweller system (FLUPSY) that is used for shellfish nursery and brood-stock conditioning. The FLUPSY has two pontoons. Each pontoon of the FLUPSY sub-unit is constructed of three 55 gallon plastic barrels such that the pontoon dimension approaches 24 inches wide by 32 inches tall by 9 foot long. The two pontoons are attached to each other to make a catamaran with a 6 foot clear span between the hulls. Upon the bow and stem of each hull is an 8 foot upright post with a pulley at the top. This is used to aid lifting in maintenance and operation. Alternately, a gantry may serve the same purpose. The clear span area of the catamaran will receive one or more FLUPSY's of claim design. This FLUPSY has a proportion configuration that may be morphed to meet the anticipated estuary tidal speed. A typical FLUPSY occupies the full length and width of the catamaran clear span excepting an allowance for clearance so that the FLUPSY may be lifted out of the water for maintenance. A typical FLUPSY has a depth of 3 or 4 feet.

It is constructed from welded steel rod, concrete reinforcing mesh, and black builders poly and tarp.

The covered panels are covered with an envelope that covers (hot glued) both sides of the rotating vane and side walls.

The assembled form of the FLUPSY approximates a trough. The side pieces (starbord and port) are each x braced rectangle panels (3′×8′) wrapped with an envelope of builders poly affixed with hot glue. The pivoting vane has a similar envelope.

In addition to bounding the flow of water, the envelopes promote the development of suboxic conditions next to the steel. This inhibits fouling and corrosion on the steel. This arrangement is very economical and ecological—painting the steel is barely justified. Also the envelope is easily replaced if fouled or damaged. The envelope will break first during storms and may spare the steel and pontoon structure by that intentional failure point.

These two two side panels have welded pin receiving pads on the top to attach the top panel. This top panel is also made of welded rod but remains uncovered by poly as this top panel will hold the frames containing the shellfish (nursery stock, brood stock, or Grow-out).

These steel frames are unpainted, but given cathodic protection. (claim 20)

The current of this protection may be turned up so as to ‘sweeten’ (agricultural pH term) the water and reduce the shellfish's energetic requirements for shell building. There is substantial but inconclusive evidence that ‘sweetening’ the water with fossil shell hash doubles oyster survival of the August ‘dieing’ time. This ‘sweetening’ requires thorough testing before it would become standard practice. The electrical ‘sweetening’ strategy will probably require license of U.S. Pat. No. 5,543,034. These disclosures are incorporated by reference. The efficiency of the ‘sweeetening’ process is enhanced when the acid enriched anode region is covered with fossil shell hash so that the dissolving of the shell hash will be enhanced. In this fashion the electrolysis does more than just create very localized and balanced regions of ‘sweetness’ and ‘sourness’ but enhances overall ‘sweetness’. A porous bag of shell hash encases the anode which is placed in the upstream (tidal dependant) entrance of the FLUPSY. The spent seaweed husks from Seaweed Soup may be necessary anode reactants as well.

Initially, the cathode is the steel shellfish container support.

In my experimental results, published in abstract by the National Journal of Shellfish Research, shows that Water ‘sweetened’ with marl appears to double oyster survival of the August dieing time. This feature is apt to have its first and most valuable usage in the FLUPSY conditioning of oyster breeding-stock. These older oysters normally experience near total mortality from diseases that have become dominant only within the last 40 years.

The establishment of this water ‘sweetening’ strategy for shellfish will also lend additional support to the widespread use of “marl” dug from Venice type real estate developments whose permitting could be much advanced by its enhancement of estuarine geochemistry in areas where iron sulfide sediments get resuspended and oxidized. Given a full set of best practices such a development would be a substantial contributor to the vitality and diversity of the Chesapeake Bay ecosystem.

Even without the substantial interventions in sediment geochemistry associated with such a real estate development the ecological goals of such a development can be largely accomplished with 50 years intense culture of a wide variety of clams with seagrass.

Within the frame of geo-history oysters represent a climax community in a succession of communities. Clams can be stepping-stones in the chain of succession. Hard clams (mercenaria) play much the same role in estuarine sediment evolution and community succession the loblolly pine plays on land where the loblolly is the first large colonizer of poor, abused, agricultural soils that have developed both a fragipan and a bit of something approaching desert pavement. Some of those soils under the influence of the community succession will divergently evolve into bog/wet lands or deeper ultisols (by tree uprooting). Estuarine and costal sediments have similar possibilities of divergent evolution and community succession into rich diversity. The speed of this divergent geological-biological evolution is such that the changes caught my attention and that observation is confirmed by the historic and periodic renewal of mined-out bog iron deposits. Given the high mobility of most estuarine life forms and the geological ordinary mass disturbance that gives estuary its name it is possible to believe that estuarine productivity, richness, and diversity can be substantially recovered within the remainder of my life. There is a path by which clam culture creates a condition that restores the dominance of the Chesapeake oyster.

If the electrolyic ‘sweetening’ strategy is going to be used for oxygen enrichment as well the anode needs to be high in the water column so the hydrogen gas will escape and the cathode needs to be low in the water column so the oxygen gas will dissolve into the water and not escape.

This is particularly important if the operational agenda includes saxitoxin dipuration. This invention may be used as an economical implementation of U.S. Pat. No. 6,171,626 whose disclosures are included by reference as are the disclosures of Leigh Lehane.in “Paralytic Shellfish Poisoning—a review”, National Office of Animal and Plant Health Agriculture, Fisheries and Forestry—Australia Canberra 2000.

The calcium ion enrichment may also be used to suppress bacteria by coagulating and compressing the bacteria's defensive mucus sheath and by flocculating them so that they tend to fall out of suspension. Mucus sheath defenses may explain much of the failure of oyster hemocyte reactive-oxygen-species (ROS) to kill dermo and MSX. Environmental strategies to compress that mucus sheath may be effective against Dermo, MSX, and human Cystic Fibrosis pneumonia. The mechanics of mucus sheath expansion are quite simple—disease chemical offenses and hemocyte chemical offenses that are delivered by diffusion are diluted and made much less effective if a mucus sheath (or fluffy calcium-limited c-lectin) effectively ‘stiff-arms’ the attack. The diffusion zone increases with the cube of the distance between combatants. The charge-to-surface area contribution of the divalent ions chelated by the c-lectin and the mucus is a strong influence on the distance between combatants. The calcium ion influence is accepted at least with respect to the ova mucus sheath block to polyspermy and the behavior of sulfated polysaccharides in food science—it has been previously applied in fish aquaculture to extent of using fuccoidan as a stress moderator and immune adjunct. The oyster hemocyte behavior published by Dr. Paynter, et. al.⁽¹⁾ is consistent with a model behavior in which c-lectin opsonizes oyster hemocyte attack on a mannose bearing disease but the hemocyte attack is held at too great a distance too be effectively targeted so the released offensive chemicals cause generalized oxidative damage to the oyster.

The mucus, or Sulfated Polysaccharide, provided by the patent pending seaweed soup assists in that flocculation/coagulation by casting a ‘mucus net’ capable of aggregating the bacteria. This ‘mucus net’ strategy is employed by tunicates but on a scale limited to their body cavity.

Because sulfated polysaccharides tend to be strong chelators of divalent cations like calcium, more calcium ions will be needed to affect the aggregation. This is particularly important when using the seaweed soup and bacteria aggregates to feed shellfish. Otherwise the relative scarcity of calcium ions could adversely affect the agglutinating defense activity (C-Lectin) of shellfish serum. This may be more than offset by the chelation enhanced bioaccumulation of calcium.

When the seaweed soup shellfish feed is cultured with probiotic bacteria and then calcium enriched it seems likely that the Vibrios that normally reside in shellfish will be overwhelmed both by relative number and agglutination/opsionation. In that Vibrio is a normal shrimp digestive flora that seems to become virulent under instances of acid forming sediment it seems likely that the effectiness of C-Lectin would be limited by a shortage of calcium ions that are AVAILABLE given the relative affinities of other chemical species in the environment. The limits of calcium ion availability to C-Lectin may prove to be the bounds of the calcium carbonate portion of the carbonate buffer system. Acidify the water until the buffer is destroyed and C-Lectin will become ineffective even though the pH may show a reasonable 7.8 due to phytoplankton production and sparging.

The electolysis/cultured-seaweed-soup treatment seems best suited to brood stock conditioning given size and expense of the process. The Vibrio load reduction in broodstock may enable order of magnitude economy and reliablity in the shellfish hatchery. Much to the current efforts in hatchery sanitation are a bit like straining at nats and swallowing camels. Unless the parents are modestly aseptic the spawn cannot be modestly aseptic. Relatively ‘clean’ broodstock at least reduces the size of the initial inoculum of potential pathogens that is delivered by the broodstock. The vain attempts at aseptic conditions appears to just make for unstable, bloom prone, larval culture conditions. Creating larvae culture conditions of optimal c-lectin and mucus barrier performance combined with a relatively natural, diverse, stable, bacterial flora appears to be both lower risk and lower cost.

Seaweed:Seagrass:shellfish polyculture will provide beneficial instances of calcium ion adequacy but the effect will not be continuous.

Give the prevailing influence of increased atmospheric CO2 on relative Calcium ion availability and the post=colonial increase in iron washout from the land and the remobilization of that iron due to the increase in waves on fine sediment bottoms incumbent to the increase in motorboat wakes in the last 40 years it seems that the three proposed strategies of 1) electrolysis/seaweed-soup, 2) Seaweed:Seagrass:shellfish polyculture, 3) marl addition to the sediment will not be adequate to the task of restoring oysters to the Chesapeake Bay.

Breeding strategies to increase the expression of alternates to c-lectins or c-lectin enabling strategies like quick-build/quick-dissolve shell inner linings maybe required to avoid windows of opportunity for shellfish diseases associated with instances of reduced calcium ion availability. To some degree achieving this breeding opportunity is just a numbers game to which no intelligence or selectivity (other than genetic diversity) need be applied. If the proposed hatchery technology is implemented brings about a 100 fold (over all) increase in oysters surviving long enough to face the challenges of adulthood then natural selection may provide our oysters with the required flexibility in immune strategies. It does seem that success would be quicker if breeding stock was selected from locations that would have faced these challenges in pre-colonial history. This breeding success would also be advanced if the shellfish where challenged in the sub 1 mm stage. This might be easily accomplished by pulse reversing the cathodic protection strategy previously described. Scientific exploration of oyster sialic-acid-specific lectin agglutination/opsionation may be helpful in speeding development of that particular immune competency.

The frames of the nursery stock containers are as large as can be reasonably handled and dimensioned such that one or a multiple of frame assemblies fully span the top steel frame of the FLUPSY made to receive them. A retaining rod of steel is placed over the nursery stock containers and pushed into the pin receiving pads welded to the top panel of the FLUPSY. My nursery stock container frames are 24 inches by 48 inches and constructed of wood 1 by 4's. The nursery stock container frames must be ridged enough not to warp and spill the nursery stock. The nursery stock containers may be lifted out of the FLUPSY for reshimming and maintenance.

The side panels also have a pin receiving pad at the middle point of the cross braces.

A pivoting vane is constructed from a 4′×8′ panel of welded steel rod. This is envelope covered and has pin receiving pads at the mid-point of the 8 foot extent for pinning to mid x brace pads of the side panels. (claim 2)

A short length of rope or rubber cord is attached to the mid point the 4′ edge of the vane. This tether will be used to set the angle of the vane so as to catch the current and force it upward through the shellfish residing in mesh covered frames. This control tether may either be rigged to a drogue for control or to a line passing between the bow anchor line and the stem anchor line where the passing line has only the play required to control the vanes.

This pivoting vane and control tether means that the FLUPSY does not need to swing with the tide, but may be anchored fore and aft so that it does not take up so much space. This arrangement reduces flotsome fouling as well. The economy of space greatly expands the number of locations that could be suitable for the operation and increases the size operation that an estuary location may host. In that the vane scoops the water up from underneath so that the water is forced up through the nursery container and out the sides (rather than the aft), these units may be effectively coupled fore-to-aft. (claim 3) The water exiting the upweller mostly escapes to the sides where the side panel prevents immediate submergence into the inlet of the downstream FLUPSY. This configuration allows better utilization of the space and fuller utilization of the water flow in that the series of FLUPSYs will tend to invert the water column so that the downstream FLUPSY takes in water that has not had its phytoplankton consumed by shellfish in the upstream unit. This configuration also provides economy in mooring and operation. The vane may be tethered in position to support tide assisted back-flushing and wash-down. Vane rotation may be limited in order to catch only the desired amount of water when current velocity exceeds needs or becomes a hazard.

When in operation the FLUPSY assembly is suspended beneath the catamaran portion of the FLUPSY sub-unit so that there is about 1 foot of water over the mesh frames so the area of water exit nearly equal the area of the water inlet. At the forward end of the mesh frame another panel of steel and poly, 1′×4′, may be pined so to prevent the top 1 foot of water from running above the mesh and so crowd the water coming up through the mesh and to aid in forcing water under the mesh frame so it presses against the vane and is hence forced up through the shellfish.

Given an average through mesh frame velocity of 2 cm per second, each SpawnToon Unit can produce about 800,000 9 mm seed over a six-month cycle. Hence the need for the BUPSY's.

Much higher velocities are possible when the FLUPSYs and other hatchery equipment wells are built for it. In this first design instance of the “Mama Cass Ostrea” which reduces this invention to practice, the hatchery wells cannot withstand high current speeds and shallow waters inhibit employing a FLUPSY proportion that would generate higher flow rates. The “Mama Cass Ostrea” may be readily moved to a higher current velocity location when the hatchery function is not needed. Also a ridged, insulated, cooled and covered live-well may be used to both delay the spawning of ripe conditioned shellfish and provide a current shadow to shelter the light weight hatchery wells (needed in higher current locations). The hatchery wells used in the more traditional larval culture may be advantageously replaced with the nested pair of open-top mesh-sided boxes or a crenellated mesh sided box (both are marsupium) used with a FLUPSY. (claim 16) (claim 7)

GROUNDING TOLERANT TIDALLY POWERED FLUPSY—If the desired location for the FLUPSY operation has swing room so that fore and aft anchors are not desired but there is shallow water so that there is a high risk of grounding then the trough and vane arrangement of the previously described FLUPSY may be replaced with a scoop made of fabric. A portion of the water captured by the scoop is vented out the back so the scoop may be purged of sediment, seaweed and other detritus without intervention. This is very important if the scoop may ever touch the bottom. The fabric scoop is light weight, relatively inexpensive and is most desirable if other constraints do not prohibit. Excess water capture can be avoided by shortening trim lines on the scoop's leading edge. (claim 9)

SPAWNTOON: Four parallel pontoons define three spaces used to suspend the hatchery live wells and FLUPSY's. A frame with deck and uprights used for lifting the wells and FLUPSY's is attached to the two center pontoons. The ‘gantry’ and working deck serves all four pontoons and all three spaces. The outer two pontoons are kept light-weight as possible and bound by breasting plank and lash to the framed center two pontoons so that the waves will be able to move the outer pontoons and thereby agitate the phytoplankton culture that spans the space between the outer and inner pontoons. The capital and operational economy of this unique configuration recommends it.

SPAWNTOON PROPULSION—DAVIS NOZZLE: The SpawnToon may contain a propulsion unit so that it may to 1) avoid storm waves or low quality water, or 2) create a current to flow through the FLUPSYs, 4) avoid the legal entanglements of a permanent mooring, and 5) acquire the legal definition of a motorboat and thereby attract less bureaucratic caprice and ludditism.

The structure and use of the SpawnToon presents a few challenges to self-propulsion. 1) The lack of enclosure recommends an outboard motor. 2) the lack of a centerline hull to shield the propeller from waves and turbulence combined with the high propeller stream slip implicit to slow speed creates a propulsion system with a great tendency to cavitation and directional instability 3) The draft requirements of the SpawnToon will vary by as much as 15 inches according the state of onboard phytoplankton culture.

These challenges to a self-propulsion strategy would be overwhelming without the claimed Davis Propeller shroud. 64 propeller shrouds and nozzles are already under patent. In a high production situation this patent design should be deployed along with the licensed venturi of a kort nozzle (U.S. Pat. No. 5,145,428) so that efficiency may be enhanced. For the sake of license-free, one-off production, using parts that may be readily purchased, the preferred and initial embodiment of this invention used plastic pipe to shroud the propeller and inhibit 1) the outward, centrifical, motion of water that causes a great loss of efficiency and a loss of directional stability (crabbing), and 2) propeller tip vorticies that increase dramatically as the propulsion system line-pull increases, slip stream increases, and thru-water speed decreases. This is caused by the high hydrodynamic water pressure aft of the propeller relative to the hydrodynamic pressure to the sides causing the outward movement of water that adds little to propulsion. Incumbent with this large pressure increase aft of the propeller comes a large decrease in pressure before of the propeller. Air tends to be sucked into the propeller causing a near complete loss of efficiency and reliability in rough water. Both the pressure differentials and the refractory time after cavitation are greater for a shrowded propeller than an unshrouded. Cavitation can become a stable condition in shrouded propellers. This is addressed in the prior art by placing the propeller deep or well under the hull. Both options have undesirable consequences in the prior art and neither option is possible on the SpawnToon. The only available option for the SpawnToon is the essence of this invention: The upper portion of the propeller shroud extends so much farther forward and aft that the lower portion of the propeller shroud that the propeller must suck water into it from the bottom and direction of travel. The side profile of the shroud is such that it compensates for the hydrodynamic pressure difference with depth while under power. No existing patent has addressed this simple objective. (claim 21)

This configuration supplies an additional benefit: Extremely shallow draft operation (in very calm water) is enabled by this propeller shroud when the outboard motor is tilted such that the intake of the shroud is parallel with the surface. When the nozzle is extended forward and tilted, operation is possible when the motor-mount is raised by light loads. Thus the Davis Nozzle meets the propulsion challenges presented by the SpawnToon.

HATCHERY LIVE WELL & CULTURE: The Hatchery Live Wells may be constructed from light tarp or plastic sheet on a frame or may be ridged and insulated. These Spawntoon live wells are supported by the estuary water and held in place by the pontoons. Typically the frame is 4′×8′. The live wells may also occupy the space between inner and outer pontoons. Given a three foot water depth each SpawnToon unit can service about 1 million shellfish larvae every hatchery cycle (30-60 days). Traditional shellfish hatchery technology and procedures are used in the hatchery live well operation. This customary enabling technology may be found in the South Carolina Sea Grant publication, “A Manual for the culture of the Hard Clam Mercanaia sp in South Carolina”

The live wells have these distinguishing features:

The flexible hatchery live well is drained with great economy and efficiency by attaching a lift rope at points on the live well frame such that the rope passes over a pulley on the lifting uprights and down to suspend a bucket of water which supplies the upward pull needed to cause the small amount of live well water displaced by the pull to flow out through the uniquely designed drainage sleeve. As the water flows out the light-weight live well is lifted so that the displacement and drainage continues until the live well is emptied.

The hatchery live well drainage sleeve consists of four parts: Conical sleeve, pipe, float, filter bag with collar. A conical sleeve is constructed from material such as the live well sheet and is attached thereto in a watertight fashion by the wide end of the truncated cone. The small end of the conical sleeve will approach the surface of the filled hatchery live well and is glued to a short length of pipe (with coupling) to which a small amount of floatation is attached. A bag of filter cloth, mesh sized to the spawn, is attached to a collar made of pipe and the assembly is friction fitted to the pipe coupling. The filter cloth bag is stuffed down the pipe so it takes a female form convenient for holding the spawn. When the sides of the Spawntoon hatchery live well are lifted a little, water will flow down the drainage sleeve and the spawn will be retained in the filter bag. As the water drains the sides of the live well will rise continuing the drainage. The conical sleeve accordions in upon itself so the drain opening will continue to drain from the surface of the water. Alternately, the conical sleeve may be replace by pipe that inclines less steeply as water is drained and the bottom of the pool rises. Under this alternate arrangement the pipe must be removed from the live-well to complete drainage and sanitation.

In this fashion the water in the Spawntoon hatchery live wells may be emptied and the spawn retained in the filter bag for introduction to another live well while this one is being washed down (with drain sleeve inverted) and sun dried while suspended on the lifting posts.

If a storm is anticipated during the two months of a hatchery batch, the live well may be drained and stored ashore or on the bottom, and the spawn may ride out the storm temporarily secured within the filter bag or some relatively safe and nurturing location.

During the veligar period the hatchery live well is filled with filtered (1 micron) nearly sterile water. During the postset hatchery period the hatchery live well is filled with 25 micron filtered water. Filters are low pressure bag type arranged in series to distribute the filtrate load such that filter bag replacement and cleaning need be done about once per duty cycle or day. Given the low lift and short run of pumping in such a floating hatchery, expensive high pressure filter housings ($400) may be replaced with 55 gallon open top plastic pickle barrels ($5). For the six filter bag capacity this amounts to a savings of $2385. One expensive pump and control is replace by several $66 pumps (in series) that need no expensing starting controls. Much less energy is used given the large pipes and short runs so one 5 kw generator is sufficient. One small sump pump is placed in a laundry basket and covered with a bag of window screen—this pump is suspended in the estuary. Its outlet pipe feeds two 75 micron filter bags (7 inch dia×32 inches long). These bags are suspended in a 55 gallon plastic pickle barrel. Within this barrel is a pump like the first in size. Its output feeds two 30 micron filter bags that are suspended in a second barrel. Within this barrel is a pump like the second in size. Is output goes directly into the hatchery wells after the spawn set. If the water is to be used in a hatchery well that contains swimming larvae then the water will feed two 1 or 5 micron filter bags suspended in a third barrel where it is pumped again. When no water is needed to fill the hatchery wells the pumps may be run to capture plankton. The plankton capture from the 5 micron bag is feed live to the postset hatchery stock. The filter bags contain a form to aid in backwash by causing the bag to assume a convex scalloped shape when flow is reversed. This change expands pores size on the inside (clogged side) of the bag and minimizes pore blinding on bag collapse. The bag may be rotated on the inner form so that all portions are cleaned and no portion goes putrid. Filter bags are also cleaned by cooking. The resulting soup is used to feed the shellfish. This soup is a fairly well balanced diet considering its source ingredients. This strategy also avoids noxious chemicals and waste water disposal issues.

The water quality of some locations is such that carbon filtration and UV treatment of the larval culture water are obligatory—A floating hatchery should just move to better water.

During the veligar period of the hatchery batch, phytoplankton food may be supplied by a modified Milford method that is unique and enabled by the configuration of the SpawnToon.

SPAWNTOON PHYTOPLANKTON CULTURE: Phytoplankton is cultured in aseptic, disposable plastic bags, about 16 inch wide by 96 inches long. The phytoplankton culture bags rest horizontally upon movable stretchers built of tarp and 8 foot 2″×4″ that span the inner and outer pontoons. (claim 35) The horizontal arrangement is structurally economical, particularly considering the forces at work on a small floating platform. The horizontal arrangement provides for a light density in the culture that cannot be achieved in a comparable (and conventional) vertical arrangement without the use of electric lighting. In addition to being unnecessary, electric lighting as commonly used in vertical arrangements would be very expensive, unreliable, and dangerous on such an inexpensive, low-profile, floating platform. Excessive light, particularly UV light, may be avoided by spraying the top of the bag with a selective UV blocking pigment. The pigments within the seaweed soup fertilizer/conditioner may be a significant aid in UV protection as well. Excess direct mid-day light may also be avoided with an array of leafed bamboo fronds.

The horizontal arrangement requires a substitute for aeration as a source of CO2 and agitation.

The stretcher can also shade to the FLUPSY that may be underneath so as to inhibit biofouling.

Openings to the algae culture bag are made from pipe fittings hot glued to each end of the culture bag. These openings are aseptically maintained when disconnected from the pumps and plumbing by a spray of household ammonia on the pipe fittings and a rubber band attached plastic bag cover. Household ammonia is superior to the commonly used muratic acid or Clorox in that clam larvae are quite tolerant of diluted ammonia and oysters seek it as a clue to good settlement locations.

The inbound piping is not disconnected from the bag during the bags use-life. During a culture bag recharge, the carbonated antiseptic fertilizer solution is both the first and last fluid through the pipes.

The culture bags are in place to continuously drip feed the hatchery. Continuous feeding enhances the feeding efficiency of the shellfish larvae for enhanced growth rates. Given the catenary of the stretcher not all of the culture will drain without blocking up the outboard end. This is good because it means that without additional management sufficient starter culture can be maintained in the log-growth which maintains culture dominance and maximizes the food value of the phytoplankton. This has the additional benefit of extended cycling between relatively slow and expensive aseptic culture restarts as well as the benefit of reaching higher phytoplankton cell densities quicker. The customary practice and enabling technology is available in the book, “Plankton Culture Manual” published by Florida Aqua Farms, and is incorporated by reference.

Given the amount of wave induced agitation the algae culture will receive on its light weight, high reserve buoyancy, floating platform no aeration is required provided that the culture is dosed with the required quantity of CO2 and O2 gas. This closed culture does much to maintain aseptic conditions even in such rough and unsheltered conditions.

Gas enriched and fertilized water for the phytoplankton culture is dispensed from old soda fountain equipment. CO2 gas tanks and regulators may be avoided by using dry ice as the CO2 source. Soda fountain tanks have a built-in over pressure valve. The carbonated water also helps ionize ammonia so that it may be used as a nitrogen source rather that nitrate. This is useful since the phytoplankton preferentially absorb ammonia in that it may be turned into protein by a cheaper metabolic pathway than nitrate. Nitrate usually must be reduced before being assembled into protein. This nitrate reduction adds to the reduction workload of turning CO2 into sugar. The alkalinity of the ammonia assists a one time initial dose of CO2 in the culture water so the CO2 does not have to be trickled in with air. Aeration is a common source of contamination in phytoplankton culture, so eliminating the need for it is a great advantage. Also the initial charge of un-ionized ammonia is quite anti-septic. That antiseptic beginning and containment does much to maintain aseptic culture. The C:N ratio of the fertilizer solution matches the Redfield coefficient (106:16) of the phytoplankton production. The pH aspect and ionic strength of the ammonia-saltwater solution helps to retain the required CO2 in the solution also. Carbon needs are also supplemented with the Seaweed Soup that is described below.

Alternatively CO2 and O2 enrichment of the gas above the culture water in the horizontal bag can be provided by an oxy-acetylene torch blown through a submerged u-shaped cooling tube into a plastic bladder that contains an air pump or an intake line to an air pump. Under this arrangement the cluture bags are not so horizontal and the enriched air is released at the culture bags low point. The gas discharge is recycled to the air bladder. Since the flame sterilized air is recycled no costly bacteria filters are needed. The gas in the air bladder is refreshed as needed.

Given the sunlight density of the horizontal culture and appropriate quantities of phytoplankton inoculant and fertility, the bag culture may be cycled every three days. The arrangement supports both continuous and batch operation. The phytoplankton culture surface of the SpawnToon unit is more than sufficient to take the spawn to 1 mm nursery.

The plankton I have chosen to culture using the seaweed soup nutrient are Skeletonema costatum and Pseudoalteromonas (NOT carrageenovora or haloplanktis with anti diatom exudates BUT P. tunicata with antifouling exudates, P. denitrificans with *antimalarial* exudeate and P. undina with antiviral exudate). Skeletonema costatum is a dominant diatom phytoplankter of the Chesapeake Bay whose DOM is reported to suppress the shellfish disease, Vibrio. Other probiotic bacteria like Lactobacillus, Propionibacterium, and Aeromonas may be incorporated to maximize culture stability and shellfish nutrition. A fullest occupation of the available bacterial niche with benign* bacteria will prevent that niche from being occupied by a potentially deleterious Vibrio. The antibiotic activity of the resulting metabolites are claimed (claim 7) as are the metabolites and soup fractions that act as metalloprotease inhibitors (claim 6). In this regard the disclosures of U.S. Pat. Nos. 6,162,786, 5,908,622, 6,054,148 are incorporated by reference.

It appears that when the C:N ratio is maintained and c-lectin and mucus barrier defenses are maintained Vibrio may not become so predatory as Vibrio are much more common than Vibrio attack on shellfish. Perhaps the shellfish loses to Vibrio described as being due to poor sanitation can have a more useful description of being due to high C:N ratio food rations that are common in over-mature algae being over fed to shellfish. High C:N ratio plankton cultures release exudates that chelate calcium and create relative undersaturation of calcium as well. As much as overly high, or overly low, C:N ratios give advantage to, and perhaps to trigger, predatory or toxic coping strategies, the ratio of shellfish to DOC sources like seagrass, seaweed, or sewage needs to be managed. The relationship between chelated calcium ions, non-chelated calcium ions, and calcium carbonate saturation also needs to be managed so that c-lectin and mucus barrier defenses may constrain Vibrios to their optimal role in the community.

The diluted wash from the aseptic practice ammonia will be utilized along with the Guillard fertilizer used in this modified version of NAOA's Milford Labs phytoplankton culture method.

3,600 to 45,000 times more estuary nutrients will be scrubbed out of the estuary and exported by the shellfish harvest than will be added in the Milford method phytoplankton culture that gets the shellfish culture started.

The two gallons of the Guillard fertilizer (Florida Aqua Farms) it takes to raise roughly 8000 gallons of high density phytoplankton which is sufficient to take 370 million clams (or oysters) to post-set, or alternatively take 30 million to nursery (if no other source of food than the Milford method is employed).

This shellfish operation is a major contributor to our efforts to clean up our estuaries and eliminate excess nutrients. This aspect makes the operation a very desirable neighbor, one that will add to the real estate value of its neighbors by making the water clean. Suburban Virginia Beach is the anticipated site of first operation. Currently this site has sanitation based restrictions; the bottom is sometimes “condemned” by the Health Department and unrelayed shellfish harvest is prohibited. 40 million clams and oysters may change all that for the better.

The phytoplankton requirements expand geometrically as the shellfish grow making additional methods of supplying food highly desirable.

The live-well hatchery food is acquired by a combination of seven methods: 1) the previously mentioned modified Milford method, 2) Wells-Glancy production in the hatchery wells that are not currently being used for spawn. 3) Non axenic production in large, shallow, flexible membrane, floating rim wells. 4) natural supply on hatchery well refills in that the 35 micron filter is the smallest used rather than the 1 micron. 5) back-flush of the five micron filter. 6) Seaweed and filterbag soup. 7) a yogurt-like probiotic cultured seaweed soup.

Surplus feed production is put in the inlet of the FLUPSY's near slack tide in order to feed those shellfish an extra portion.

The Revolutionary No Phytoplankton Culture Hatchery

There are locations which have both an abundant supply of healthy phytoplankton and an abundant supply of good water. In these locations phytoplankton culture could be entirely dispensed with were it not for the somewhat optional temperature-controlled broodstock conditioning. This FLUPSY hatchery design makes good use of these locations that appear to be at the mouth of some suburban estuaries or just upstream of sand bars that receive a fair quantity of bird droppings at low tide.

When estuary conditions are supportive the marsupium equipped hatchery FLUPSY can replace the traditional live-well culture at great advantage. The marsupium styled shellfish container used in a hatchery FLUPSY is a nested pair of open-top mesh-sided boxes. (claim 16) In this case the mesh of the inner-most box is between 25 and 150 microns. The nested box frames mate snugly at their bottoms. The tops are open for observation, handling and cleaning. The upwelling of water passes up through the bottom mesh of both boxes excluding shellfish larvae predators and competitors (in their non-larval stage). The outer mesh covered box frame accumulates the bulk of the fouling. That outer box frame may need to be swapped out for cleaning everyday unless the underwater portion of the FLUPSY has its opening covered with screen angled to the flow of water such that jellyfish are largely excluded and deflected. An abundance of zooplankton and dertius eating minnows and shrimp are kept in the space framed between the two nested mesh boxes. (claim 15) In some estuaries bryzoan, tunicate and mussel biofouling can be so intense the BUPSY culture is unsustainable because of the maintenance burden. Under these conditions this hatchery design can serve for nursery duty as well provided that the mesh is sized appropriately. This design is more expensive but it would be justifiable in that high biofouling waters usually support rapid shellfish growth.

The water flows out through the sides of the nested mesh covered frames as is fitting with the FLUPSY design. The spawntoon hulls on port and starboard prevent waves from topping the container and contamination the contents with shellfish larvae predators and competitors. The natural supply of food is relied on to a large degree but cultured phytoplankton, seaweed soup, and probiotic culture may be added during the two hours around every slack tide (eight hours per day). The open top boxes are about two foot deep with the portion of the sides being solid or tape covered for reasons of strength, economy, and veliger refuge from out-flow pressure since they congregate on the water's surface. The nested boxes are rectangular and have a proportion of length to width (or crenallation) that allows for about twice as much out-flow side mesh as inflow bottom mesh. This help prevent the current from pinning the veligers against the out-flow mesh. The mesh can be masked at the surface so that rafting larvae can find refuge from the current. The vane angle is also adjusted to prevent too mush flow though the set of nested boxes. A moderate wave surge helps free the veligars as well. Multiple sets of nested boxes can be arrayed in one FLUPSY. A space is maintained between the sets of nested boxes to allow for the out-flow water. The space between the sets of nested boxes is floored at the level of the box bottom to both support the nested boxes and shield the mesh sides from water pressure that would inhibit the out-flow. A top-hinged, bottom weighted curtain hung across the fore and aft ends of the array further shield the mesh sides from water pressure that would inhibit the out-flow. The curtains may be lifted and the vain reversed for a modest back-flush. Frequent backflushes may be required during jellyfish blooms. This need for backflush may be diminished by the use of a device to screen the incoming water and deflect the jellyfish and seaweed. The screen meets the water flow at an angle so that the excluded fouling may be deflected. To achieve this angle of attack the screen is made as a bow and stem fairing and the bottom of the FLUPSYs are closed in so that fouling will not be captured on the inside of the down-current screen. An abundance of zooplankton and dertius eating minnows and shrimp are kept inside this vane housing to further reduce biofouling and mesh clogging.

Highly concentrated larval culture in this device has two advantages: The high concentration of shellfish eggs appears to impart an enhanced degree of protection from deleterious bacterial attack by means of ovomacroglobulin like agglutination of certain bacteria. The agglutination is only effective if water flows are not overly vigorous and turbulent. An oxygen enriched atmosphere over the culture can allow flow to be reduced—not so much because of oxygen penetration into the water but because of larval rafting behavior at the surface. When larval rafting behavior is displayed the mesh openings may be cleaned with a suction hose without losing too many larvae. The parent shellfish stock should be both highly conditioned and depurated/feed with probiotic bacteria to minimize the initial ratio of potentially deleterious bacteria (like Vibrio) to spawn.

The theoretical hatchery capacity of the marsupium-FLUPSY approaches two million per square foot per operation month.

The expense and fragility of the fine mesh on the boxes recommends the use of a gantry to handle the open top boxes.

SEAWEED SOUP FOR SHELLFISH AND PHYTOPLANKTON NUTRIENT: (claim 12) A soup is made from cooked seaweeds such as Gracilaria, Ulva and Enteromorpha and fed to the shellfish and plankton. This soup emulates the dissolved organic mater (DOM) and single cell detritus ordinarily released by seaweed and phytoplankton and utilized by both shellfish and phytoplankton.

The Seaweed Soup provides phytoplankton with a complex brew of micronutrients and a metabolically inexpensive source of carbon that is also less chemically reactive than CO2. The economy of this Seaweed Soup strategy is astounding and unique to this patent. The seaweed soup contains considerable amounts of refractory POM and DOM that appear to enhance filter feeders' efficiency in capturing very small phytoplankton and bacteria by means of a mucus net. To some degree this mucus net allows the shellfish to remove deleterious bacteria by preying on them.

The seaweed for the seaweed soup (and other marine products) may have be enhanced by hypersaline treatment prior to use. The hypersaline treatment increases the content of osmoregulators, like dimethylsulfonpropinate (DMSP). These osmoregulator chemicals are also relied upon by many life forms as a feeding cue since their food is apt to release a plume of these chemicals when ever it rains. It seems that I respond quite vigorously to this scent as a feeding cue. Should a significant portion of other humans respond in a similar fashion then hypersaline treatment of seafood and live feed for the finish feeding of cultured seafood will become an important discriminator of product quality. These osmoregulator chemicals appear to enhance product shelf life as well. The beneficial antibiotic and antifungal effect is apt to be due at least in part to the enhance concentration of propanate salts. U.S. Pat. No. 6,054,148 (claim 6)

The seaweed soup is cooked in a pressure cooker so that the more volatile content will not be lost. These volatile fractions include much of the flavorful and antibiotic ingredients of the seaweed.

The soup has the seaweed husk strained out of it before feeding it to the shellfish so that the upwellers and hatchery wells will not become fouled. The effectiveness of this strategy is evidenced by dramatic increases in shellfish excreta. The seaweed soup can be solidified into a slow release mass by mixing in a calcium source like CaOH. The solidified mass is less somewhat soluble in times of high phytoplankton productivity than it is in times of high bacterial respiration. (claim 14) The solidified seaweed soup can be economically dispensed to FLUPSY housed shellfish by putting it in a high aspect ratio basket basket held out board of the FLUPSY inlet by a distance that is roughly half the circumference of the basket. In this position a two leaf sheet of plastic can be attached to the FLUPSY most line of the basket such that the current will wrap the sheet around the basket when the basket is down current of the FLUPSY and alternatively will unwrap and expose the solidified seaweed soup inside basket to be eroded by the current when the basket is on the up-current side of the FLUPSY. In this way two baskets one on each end of the FLUPSY will enrich the water feeding the shellfish while simultaneously minimizing management and feed loss. The calcium saturation of the seaweed soup reduces the potential for ETDA like effects on C-lectin immune defenses and increases the tightness of the bacteria aggregating mucus net that is produced by the seaweed soup. The tighter aggregate seaweed soup flocs appear to have a larger portion of clam food sized particles when it is being feed. Shrimp are highly attracted by the solidified seaweed soup. The solidified seaweed soup may also find a market as chum.

Unless the nutrient inputs are balanced by other ingredients and/or enhanced by the culture of probiotic bacteria and possibly probiotic mixotrophic phytoplankton, this strategy should be limited to brood stock, nursery stock, phytoplankton culture and shellfish depuration/finishing. When the soup is cultured with probiotic bacteria the deleterious bacteria are purged by the feed through-put and probiotic interactions and competition. (claim 15) To some degree this mucus net allows the shellfish to remove deleterious bacteria by enabling the shellfish to graze upon them.

In depuration/finishing the Seaweed Soup can provide a few last meals that ensure fat, sweet, tasting shellfish without the bitter after-taste that occasions some natural plankton. (claim 13) The dipuration of deleterious bacteria like Vibro is a significant benefit also. Given the known chemical behavior of saxotoxin it appears possible that this shellfish toxin would decompose when exposed when the shellfish is depurated in electrolytically sweetened water. (claim 20).

Seeing that taste and reliable quality is much more important than price in most markets the markets may evolve to make dipuration using this feed and cooled live-wells with extra salty, extra alkaline, highly oxic, water practically obligatory.

As this hatchery patent provokes an increase in production that perturbs the market this is apt to become more true. Cooperative marketing with certain application of best practices and depuration/finishing will have increasing appeal.

I hope that the shellfish producing community will trust me to perform this finishing and market organization for them. To foster that trust I hope the make gift of a million shellfish per year license on the TWWELLER. I hope to promote a marketing environment much like the market for cows' milk so that the economic and environmental benefits of shellfish culture can be maximized. The environmental uses of shellfish culture named in claims 18 and 19 could provide a market parallel to that of ‘manufacturing milk’.

BUPSY (BOTTOM UPWELLER SYSTEM) (claim 4): When the nursery stock has grown to a point that the FLUPSY's can no longer service the volume a suitable proportion of the nursery stock is placed in a kind of upweller that is unique to this patent. Also, the capital economy of the BUPSYs compared to the FLUPSYs may encourage the use of BUPSYs as a complete replacement for FLUPSYs when estuarine conditions are supportive. FLUPSY's are sometimes more economical to maintain in that they are not normally on the estuary bottom. This patent has three BUPSY designs so that the BUPSY deployed can be more economical for a give set of estuarine conditions. The first BUPSY design utilizes a mesh frame container like the FLUPSY of this patent. The range of meshes varies from 25 micron to 1.5 inch to match the needs of hatchery, nursery, Grow-out, Brood-stock conditioning, and depuration/finishing.

My high current implementation consists of two 36 by 48 inch shellfish containers (of this patent design) set within a steel frame and strongly anchored. This BUPSY steel frame provides the strength needed to withstand the high currents that maximize stocking density and growth. That current also requires the “Davis Harpoon Anchor” of this patent. Three foot long screw anchors have washed right out of the bottom. The 3 foot by 8 foot BUPSY frame has an isosolese triangle extending eight inches down from the three foot sides. The triangle's apex provides a pivot point for the BUPSY. When the triangle is made of rope the BUPSY may be rotated to ease cleaning and trouble bottom surface seeking biofouling. Current capture is enhanced if the triangle is made plane rather than frame.

The pivot of the BUPSY frame is controlled by a floating drogue that is bridled to the BUPSY such that it pulls the upstream 8 foot edge the BUPSY up so that the flow of water is wedged between the bottom and the plane of the shellfish container such that much of the impinged water is forced through the shellfish container.

The attachment, whether by rope or cable clamp, allows for downward adjustment once the current around the BUPSY digs a scour hole. This downward adjustment puts the BUPSY within the 12-inch projection limit defined by Virginia Law for non-special permit aquaculture. The downward adjustment into the scour pit also helps protects the BUPSY from propeller damage.

The attachment may be loosened so the BUPSY may be slide up the anchor cable and lifted clear of the water for maintenance. The clamp may be locked to enhance security. Security against theft is also enhanced by the high current speed and the size of the BUPSY. Very few people would be capable of actually stealing the seed shellfish so those that might are more likely to be caught.

When made of steel, the triangle is splayed out four inches to ease the labor of anchoring and inspection.

The BUPSY is lowered to the estuary bottom with the Davis Harpoon Anchor string bound within the splay of the triangle and the wash-pipe placed in the anchor's tube. The Davis Harpoon Anchor is then washed into the bottom much as sheet piling is washed in.

The anchor cable will be buried in the bottom so the anchor line length will be the anticipated anchor wash-down burial distance plus the water depth, plus the distance needed to lift the BUPSY onto the deck for maintenance. A marker float is attached to cable.

The assembly may tip so that it rests upon one side of each triangle and the high point of the BUPSY is about 16 inches high from the apex.

The BUPSY may now rock on its pivot and not extend more than twelve inches above the bottom. The excess tip that can come with excessive scouring can be avoided by 1) a frame on the bottom that is attached to the apexes, and holds the apexes up, and limits the tip of the BUPSY frame; or 2) by shortening the anchor line.

Alternately, the mesh frame may pivot in two side walls projecting from the bottom and arranged so as to maintain the 12 maximum projection from the bottom. This second arrangement makes a slightly better use of the current but it is not my preferred embodiment as I have plenty of current available. This 12 inch requirement is a portion of the Virginia Code so that this BUPSY needs no permit when it is placed on leased bottom.

Periodically the BUPSY's will need inspection and adjustment. This operation requires a man in the water. The mesh frame sets are unclamped from the steel BUPSY frame or the complete BUPSY is lifted clear of the water. Air and sun drying of the seed may be needed to kill biofouling attached to the seed itself. The fresh water wash normally used for this purpose in land-based culture may be sorely missed unless arrangements for a recycled freshwater or brine wash are made.

Growth rates are such that BUPSYs are justifiable for grow-out as well as post-set hatchery and nursery operations. Given an average through mesh frame velocity of 6 cm per second, each 24 square feet of BUPSY is expected to produce about 1,000,000 9 mm seed over a six month cycle. The economy of this device is astounding.

The BUPSY will affect sediment scouring and deposition in its immediate vicinity. Putting a small foot on the bottom rail can materially aid in avoiding sedimentation by creating a high current velocity scouring region where the BUPSY touches down on each pivot. Scouring such that the BUPSY rests in a hole can be managed to advantage where the current is fast enough to form a “bedding plane” or dune on the bottom. In such a current maintained hole the BUPSY is much less likely to sustain propeller damage. As a benefit of the community, an array of BUPSYs (spaced to enhance or diminish deposition between the scour pits) can be placed to enhance channel scouring, depth, and definition. The anchors needed for the BUPSY's under high current circumstances are described as follows under “harpoon anchor”. Oyster cultch beneath the BUPSY limits scouring and provide and opportunity for polyculture.

My moderate current implementation consists of an individual 36 by 48 inch shellfish container, anchored with sand bags, and pivots right on the shellfish container where the sand bag is tied. Rotation for cleaning is very easy. This has great capital and operational economy that largely offsets the reduced carrying capacity incumbent to reduced flow. This diseconomy is more significant in summer than in winter. This design may be carried off by the current and is easy to steal. A conventional cable mooring system can help secure a sting of these BUPSY's against loss.

My lower current implementation (claim 8) and possiblely the best overall implemetation, consists of a shellfish container that is about 8 inches by 72 inches. It has two mesh envelopes 8 inches by 30 inches with one 30 inch side open. A one inch by four inch boards attached to one lip of the 30 inch opening in the mesh envelopes. This leaves a 12 in clear space in the middle to make handling the BUPSY easier. Once the mesh envelopes are loaded with shellfish another like board is screwed into the first so that the mesh envelopes are firmly closed. A suitable amount of floatation is attached to the boards and then the boards are bound to sand bag anchor in the middle such board will float no more than 12 inches above the bottom. The assembly is placed in the estuary so that the 72 inch dimension is at right angles to the current flow. The hydrodynamics of the device will manage its orientation to the current like it where a sea fan.

The mesh envelope weighted with shellfish will hang down to obstruct the flow of water so that it is forced through the mesh to the shellfish. The mesh envelope will be lifted by the current such that it will take the shape and flow of a crude foil; under these conditions the water flows up through the shellfish to help unpack and clean the mass of shellfish. The economics of this construction and ease of handling may make this design superior in almost all nursery conditions. Should this assembly be struck by an outboard motor the movement of board and sand bags will shrug off much of the blow. The mesh envelope is also protected by the strength of the board above it and the light weight of the whole assembly. As always, the BUPSY is marked to meet the requirements of Virginia law and to avoid such encounters. This design may be carried off by storm and is very easy to steal. The addition of a conventional cable mooring system can help secure a sting of these BUPSY's against loss.

The balance point handle makes this design a relative pleasure to work with. The design also mates with a oscillating screen to assist with splitting a BUPSY's contents into two BUPSYs while cleaning the seed and the original BUPSY. This operation needs to be performed every week or two to accommodate the seeds' growth and ensure that the mesh stays unclogged.

TWWELLER (Two Way upweller/downweller): (claim 5) (FIG. 11) The TWWELLER (Two Way upweller/downweller) is a shellfish growing device with opposing flexible scoops opening on both the upestuary and down estuary moored ends of the device. The shellfish are placed in a roughly hortizontal mesh container between the two scoops. On the changing of the tide the scoop that was an inbound scoop becomes an outbound cowling and the flow through the mesh changes direction so the mesh and scoop/cowls will tend to clear themselves of fouling—the device oscillates between up-weller and down-weller. Clearance is assisted by the very flexible (and inexpensive) construction of the scoop/cowlings which transfer wave energy through the device with as little non-shellfish container obstruction as possible, thus maximizing the force available to dislodge fowling. The scoop/cowlings obstruct and bind a flow of water such that it is forced through an attached mesh shellfish container. The bridle may be connected to the mooring line by a swivel and the scoop/cowlings may be asymmetric so that they combine to form a screw like shape which imparts a mild rotation to the device.

THE DAVIS ‘HARPOON’ ANCHOR (claim 23) (FIG. 10) is a permanent (or disposable) mooring and aquaculture anchor with exceptionally high holding power and low weight and cost. The anchor is washed into the bottom much like a piling may be washed into place. The anchor is made from a steel pipe with length to width ratio between 6:1 and 36:1, and with about half the cylinder removed for about one half its length. The trough portion of the pipe length is bent outwards from the axis of the whole pipe to an angle of less than 45 degrees. A brace may be welded on the outside of the pipe to strengthen the trough section. The pipe is pierced with a pin or bolt near the two-fifths point of its length and on the heavy end of the pipe length. This pin attaches the anchor line with the attachment inside the pipe and the bitter end extending out through the lighter weight end of the pipe length. The pipe and anchor line assembly are fit over the end of a wash pipe that is about ten foot longer the depth anchorage water. The wash pipe is like that used to wash pilings and bulk heading into the bottom. The anchor, mooring line, and wash pipe combine to vaguely resemble an Eskimo harpoon. The wash pipe pump is started and the anchor is washed into the bottom as deeply as may be practical. The anchor is kept on the tip of the wash pipe by tension on the anchor line. When the anchor is at setting depth the wash pipe is pulled free of the anchor and the anchor is pulled so that its barb causes it to turn horizontal while the immediate region is still fluidized by the wash pipe. Another wash pipe tied to the tip of the anchor barb with breakable string is helpful in turning the barb.

Infrastructure Benefits & Combined Real Estate and Shellfish Culture “Best Practices”

Given the value of waterfront real estate and the realities of politics, shellfish aquaculture must be an advantageous and friendly neighbor otherwise it will not exist. The environmental benefits of shellfish culture can ease some of the regulatory and political difficulties incumbent to any estuary front real estate development. Moreover shellfish culture can extend landscaping into WetScaping for a cost effective and profitable enhancement to estuary front real estate developments. Sixteen inventions are proposed to assist the dovetailing of neighborhood and shellfish aquaculture interests.

1) Beach protection & building by beach foreshore enhancement

2) Channel Depth maintenance and development by Shellfish mediated beach and bar building

3) Channel Depth maintenance and development by BUPSY and foil array

4) Erosion Control Groin made of Shellfish and Seagrass Polyculture

5) Hazardous Algal Bloom Management by Shellfish:Seagrass:Seaweed Polyculture

6) Acid forming sediment rendered more benign by marl amendment

7) Iron sulfide and other sediment toxin sequestration by marl or sand with shellfish and seagrass armoring.

8) Marsh grass and bottom slope reinforcement

9) Spartina: Oyster Reef and Mitigation

10) Spatina mitigation with Oyster Reef

11) Reef Warf & Upweller

12) Canal Maintenance by Aeration and Shellfish

13) Waffle bulkhead

14) Seagrass mitigation

15) Spartina mitigation with Seagrass

16) Stinging nettle abatement by shellfish culture

1) Beach Protection & Building by Beach Foreshore Enhancement

Shellfish such as Donax, Spidula, Mercenaria can build beaches by building the beach foreshore. In oceanfront locations such as Sandbridge, Va. it may be the only politically and economically feasible solution to the loss of houses to the ocean. This usage has never been utilized before seeing as the shellfish seed was not available at a cost that made the usage imaginable. When clam densities approach one million per acre those clams capture nearly every piece of sediment that comes their way. This is evidenced by the practice of placing floats in the predator exclusion nets of clam Grow-out beds so that the clams may move upward as the sediment accretes. During a storm event the larger clams armor the bottom with their shells preventing much erosion. 100 year wave events (est.) such as the Ash Wednesday storm in the early 1960's destroy shellfish beds and setup conditions for erosion that appear stable unless shellfish culture intervenes. It has been nearly forty years since that storm and Donax is just starting to return. I remember populations of Donax that moved with the surf s landward edge and numbered over one clam per square inch. Such a population effectively increases the grain size of the beach surface and radically enhances sand capture and retention. This dynamic for Donax (but not completed with the larger Spisula) can be viewed on the beach at Fort Story/82^{nd} Street in Virginia Beach, Va.

Given considerable shoreward migration and capture of the fine sand; the course shell and cobble would be exposed in the deepened portions of the shore slope and ocean front oysters might prosper once again as they must have done before they where cast ashore in the Ash Wednesdays Storm. Should those clams and oysters not be harvested they are apt to become a substantial shore defense and an ecological and fisherman-tourist bonanza.

Oyster beds at the moth of an estuary can seed the whole estuary when freshwater flows out on the surface and salt water flow in on the bottom. This dynamic formed the seed oyster performance of Virginia's James River.

2) Channel Depth Maintenance and Development by Shellfish Mediated Beach and Bar Building

Shellfish Grow-out can build and stabilize sand bars whose sediment would otherwise move into the channel. The developing bar forces the flow of water around it so that the bar creates conditions of increased scouring within the channel of flow. This usage has never been utilized before seeing as the shellfish seed was not available at a cost that made the usage imaginable. (claim 18)

3) Channel Depth Maintenance and Development by BUPSY (or Foil Array)

Shellfish Grow-out in BUPSYs can create channels directly by scouring the bottom in their immediate vicinity. The tilt of the BUPSY may be constrained so that the sediment is moved in one direction. When directional movement of sediment is desired it will usually be desired to move the sediment to counter-act the typical infilling that occurs at channels through the mouth of an estuary. BUPSYs in this usage should be a blend of the moderate and low current designs in consideration of the high volume of boat traffic that will occur directly over them and that a rare contact is likely even with a full complement of best practices and scour pit protection. Under channel BUPSYs may have their frames made from a 70 degree section of a plastic 55 gallon barrel so that the BUPSY is about 36 inches by 14 inches in size.

There are locations like Rudy Inlet in Virginia Beach where the natural long-shore transport of sand is somewhat interrupted by a pair of jetties and a boat channel. Constant channel dredging is required as long as the channel is the terminus of the long-shore transport. A string of BUPSYs may be used to continue the long-shore sand transport *underneath* the channel. Under this scenario shellfish production might not be a significant consideration so the mesh would be dispensed with in the middle of the 36″×14″ section need not be cut out. In this usage the section is just a foil to increase out bound current speed next to the bottom. These foils are strung in series on cables clamped to the barrel section top and bottom (14″ face). The string of foils stretched across the channel, on the bottom. The foils are strung so that they face 45 degrees to the channel. When arrayed in this fashion, both the in:out and the north:south currents are used to advantage. In this location, wave induced water movement is a large contributor to the in and out currents of water. On the inbound flow the down-most, ocean facing, edge of the foil will be forced to the bottom, decreasing in inward current speed at the bottom. Current speed at the bottom determines sand transport. On the outbound flow the up-most, land facing, edge of the foil will be capture the current and accelerate it through the smaller opening next to the bottom. The enhanced current will be deflected so that it is more normal to the foil so that the sand will be transported from one foil to the next until the channel is traversed. The sand under the foil array will be scoured away so that the whole array rests in a scour pit and preserved from contact with vessel keels. In locations like Lynnhaven Inlet that have well developed flood and ebb channels, the string of foils would be placed in the non-navitable flood channels that flank the outside of the inlet and are the source of most of the incoming sand. In this case the array of foils transports the sand counter to its ordinary direction of movement. When combined with seagrass:shellfish culture sand traps maintenance dredging could be reduced to a small fraction of current requirements. (claim 10)

Beach replenishment dredging may be likewise reduced by Donax and Spisula culture.

Most channel development usages of the BUPSY will not be so critical or persistent in that they will be used to scour and develop channels into shellfish flats so as to a) increase the food quality of water irrigating the flats by reducing the average distance from a channel, b) increase the diversity and edge area within the flats, c) increase the roughness of the flat for increased bethnic:plegic coupling, d) and create more bottom areas with ebb dominant slope and energy profiles so that those areas may become productive for oysters, e) and distribute that ebb dominant profile over a larger area so that the erosion associated with that profile is reduced along with the distress that comes with the sedimentation that is the complement of erosion—oyster culture on that ebb dominant profile further reduces erosion. (claim 19)

BUBPSY or foil scouring usage has the additional benefit of exposing buried oyster cultch. The scarcity of oyster cultch is one of the factors that most limits oyster restoration. Traditional dredging makes for a total loss of that cultch. Oyster cultch is preserved and exposed when BUPSY or foil scouring substitutes for dredging.

The string of foils is also used to save a clam bed from an excessive accumulation of sand.

The string of foils may also be used to assist in the harvest of clams and seagrass propagules. Without the gentle assistance of the foils propagule harvest would see much damage and loss to the propagules and the expense is apt to be more that a fledgling market for seagrass propagules could bear. Without the clam:seagrass polyculture all restoration efforts would necessitate some damage to wild seagrass populations. It is also rumored that seagrass propagules can be tender and sweet tasting and could be selected and breed for leek like proportions.

BUPSYs can build channels indirectly when they increase the hydraulic roughness of their flat so that scour is enhanced in the nearby channel and sediment capture is increased (overall) on the flat. (claim 19)

4) Erosion Control Groin Made of Shellfish and Seagrass

The bulkhead groin, a traditional, controversial and un-neighborly erosion control device may be advantageously supplanted by a living groin made from a bed of shellfish, sub-aquatic vegetation and predator exclusion net. A Spidula:Donax:Seagrass:Net Groin is suitable for some oceanfront uses. This polyculture has much broader application than self-funding erosion control. (claim 18)

Seagrass:Macroalgae:Phytoplankton:Clam:Oyster

POLYCULTURE: 5 inventions and 9 claims in this patent support polyculuture of seagrass, algae, clams, and oysters They are: 1) a fence used to retain drifting macro algae (claim 27), 2) the use of clam predator exclusion net to anchor and culture seagrass (claim 30), 3) the topside use of clam predator exclusion net to culture oysters (claim 26), 4) oyster culch exposure/maintenance practices of directed bottom scouring and complementary sediment accretion with diagenisis, 5) a structure intended to replace erosion control groins and make such un-neighborly structures environmentally and economically obsolete in all but the most high energy environments (claim 18), and the use of seagrass root culture to grow a biological substitute for clam predator exclusion mesh (claim 25).

Algae and the filter feeders can benefit each other such that the combined association can constitute a guild. A fence to is used retain substrate detached macro algae in order that the algae may condition the water passing to and from a shellfish culture area and provide an opportunity for polyculture. (claim 27) When nitrogen fertilizer becomes depleted the algae increase their exudation of organic mater (DOM & POM) with a high C:N ratio. Some of the exuded DOM is used as an energy source by bacterio-plankton. Other portions of the exuded DOM are refractory but they still enhance microbial growth by providing a substrate. Thus fortified the bacterio-plankton scavenge the increasingly scarce fixed nitrogen. Their small size and high surface to mass ratio enables them to compete more effectively for scarce nutrients like fixed nitrogen than larger phytoplankton or seaweed. When the current returns the bacterio-plankton as a prize to the guild's filter feeders the guild's algae receive the excreted nutrients and are thus “paid” for the DOM they exuded. If the Zostera's cohort of shellfish has been harvested it is logical that the strategy would no longer be profitable to Zostera and they would display the “wasting disease”.

The refractory DOM also appears to increase the filter feeders' efficiency in consuming bacteria and smaller phytoplankton. The mucus forming sulfated polysaccharide refractory algal DOM is different in its effect on an estuary than refractory DOM of terrestrial origin. It appears that modest quantities of refractory mucus-like algal DOM would suppresses pfiesteria and other large predatory dynoplankton by enhanced filter feeder capture of nanoplankton. In as much as refractory algal DOM reduces the refuge from grazing pressure that is attributed to very small size, refractory DOM moderates blooms and promotes phytoplankton diversity.

Direct DOM absorption is also reported to be a substantial portion of larval filter feeder nutrition and is reported to subsidize mature filter feeders as well.

There is an astounding, almost bewildering, array of biologically active ingredients in seaweed. The properties of seaweed DOM and POM are reported to be antibacterial, anti-fungal, antiretroviral, anti-inflammatory, anticancer, anti-malarial, probiotic, chelating and nutrient. The operational significance of any of these properties is not known by me but the more labile portion appears to be so beneficial that many life forms, including myself, are genetically sensitized to some sulfated polysaccharide metabolite, possibly dimethylsulfonpropinate (DMSOP), and respond to it as an feeding queue. The cuing chemical content of Lynnhaven River oysters was probably very high on one day when I was fourteen and eat one hundred and fourteen oysters. The more labile and low molecular weight sulfated olgosaccarides appear to be more drug-like. The higher weight sulfated polysaccarides are reported to enhance the effectiveness of the lower-wieght. To me, eating oysters is a bit like tasting wine.

Algal DOM is also a strong chelater and detoxifier of heavy metals such that the DOM enhances the vitality and growth of the entire neighborhood. Shellfish are also reported to use this DOM as a spawning cue. The assembly of DOM chemicals that accomplish this have been named “ectotrine”.

The DOM releases of brown and red alga macro algae also appear to help trigger the spring phytoplankton bloom and may do so in part by their detoxifying influence. At least the desirable spring and fall blooms do not seem to be temperature controlled. And with respect to phytoplankton culture it is known that chelators are required for bloom whether they are added by the culturist or the phytoplankton.

These beneficial properties of sulfated polysaccharide DOM may explain a significant amount of the increased shellfish growth and survival when properly associated with algae and seagrass beds.

The typical die off of second summer oysters appears avoided in one lagoon that has both stable sediment and large quantities of Gracilaria. Algae related, naturally occurring compounds may be active against oyster MSX and/or dermo infections. Another factor contributing to shellfish health may be that CO2 and sulfate consumption by the algae increases calcium carbonate availability saturation for enhanced shell building and c-lectin immune function. The water chemistry is such that 1 gram of algal sulfated polysaccharide construction enables about 3 grams of shell building. The sulfated polysaccharides also directly aid the shellfish in their bioaccumulation of Calcium by chelating the Ca++ ion. The chelation also aids mucus barrier immune defense effectiveness.

Seagrasses have much the same guild relationship with filter feeders as algae except that seagrasses appear to release much of their DOM at their winter regression and thereby extend the fall shellfish growing season. The Chesapeake Bay brown and red algae appear to release most of their DOM during their summer breeding and regression, thereby extend the spring shellfish growing season.

In addition to promoting shellfish growth, seagrass culture can provide mitigation, sediment capture, environmental and landscaping benefits.

Established seagrass roots can also be grown as a substitute for clam plastic predator exclusion mesh (claim 25). The seagrass can be seeded with a light population of clams under PEM. Once establishment of the seagrass is reasonably secure the PEM can be shifted for reuse and more clam seed can be “drilled” into the seagrass much as soybeans are “drilled” into wheat stubble. This strategy can reduce PEM maintenance costs, harvest costs, and could be a politically advantageous way to increase yield.

5) Hazardous Algal Bloom Management by Shellfish:Seagrass:Seaweed Polyculture

Within the context of the Chesapeake Bay it seems that HABs are dinoflagellates. The offenders are Aurecococcus anophagefferens, Prorocentrum minimum and Pfiesteria piscicida.

Shellfish:Polyculture strategies to diminish Aurecococcus and Prorocentrum blooms are handled first and together in that they are both photosynthetic and dinoflagellate. Neither Aurecococcus nor Prorocentrum are reputed to have virulent toxins. The damage they do seems to be mostly colatteral. Both are reported to begin blooming in small embayments with minimal mixing. In this pattern, the dinoflagellates Aurecococcus and Prorocentrum, fit into typical transition between diatom dominance in the winter and flagellate dominance in the summer. These transitions are not strictly seasonal.

The ascendancy of dinoflagellates over diatoms is usually predicated by one or more of the following conditions:

1) relative deficiencies of the dissolved silica nutrient required by diatoms but not dynoflagylates

2) relative stability of the water that enables the motile dynoflagylates to remain high enough in the water column to receive the required light while the diatoms sink into the darkness.

Typically the transitions between diatom and dinoflagellate dominance are unnoticed because most ascendant phytoplankton are not hazardous or do not always express the hazard even if they are capable. And by fortunate happenstance (or evolutionary design) the conditions promoting a drastic decline of the diatom population are diminished by clam:oyster:seagrass:seaweed polyculture. Moreover the culture may be cost effectively managed to accentuate those features. Both proactive and remedial strategies are available to promote the health and diversity of the phytoplanketon in the waters influenced by the polyculture. Given the relative masses of water, those transitions out of diatom dominance are influenced not controlled. The dinoflegellates and flagellates can have their ascendancy moderated.

Proactive Benefits in Shellfish:SAV Polyculture

The proactive tending of the ecosystem to avoid the dinoflagellate HABs is greatly facilitated by shellfish:seagrass:macroalgae polyculture. An estuary that is optimally tended from both and ecological and an economic perspective will have a sufficiently large area of shellfish:seagrass:macroalgae polyculture to proactively avoid dinoflagellate HABs by:

A. Having large standing stocks of (non silica requiring) aquatic vegetation available to absorb and buffer nutrient pulses of nitrogen or phosphorus, so that relative silica deficiency is much less likely to occur.

B. Having an increased hydraulic roughness of its bottom due to the presence of seagrass and shellfish mounds. The modest turbulence induced by this small scale roughness increases the thoroughness of water column mixing to distribute nutrients and lift the higher sink rate diatoms.

C. Having both a high local filter rate and a high degree of sediment armoring shells and seagrass, the estuary will have higher clarity water with a larger photic zone so that the higher sink rate diatoms are at less of a disadvantage on calm days.

D. In calm shallow clear waters the bottom will absorb more sunshine than the water column so that the water next to the bottom will be warmer and lighter in weight such that it will rise and prevent stratification even when there is no wind or current. This is rare but this happens at what might otherwise be the apex of dinoflagellaate dominance. Under these conditions semi-bethnic diatoms are apt to be at a nutrient advantage relative to flagellates.

The nutrient buffering and toxin chelating aspect of the polyculture are probably most significant. The influence of the polyculture is large relative to its size because of the dissolved organic matter (DOM) excreted by seagrass and seaweed during periods of spawning, nitrogen deficiency, and seasonal regression. The DOM is a mix of nutrient and refractory polysaccharides of high C:N ratio that create a growth opportunity for mixotrophic and heterotrophic picoplankton that are better able to scavenge nitrogen because of their wide dispersion and high surface to mass ratios. The shellfish in the polyculture harvest the DOM and its cohort when the current returns the DOM to the polyculture. The refractory mucus forming sulfated polysaccharides provided by the vegetation of the polyculture acts to increase the filter feeders efficiency by increasing the viscosity of the water and by increasing the effective size of bacteria by aggregation in the mucus net provided by the sulfated polysaccharides. The vegetation is paid for its DOM with the ammonia rich shellfish excreta. (claim 27) The excreta is committed to the bethnos where the rooted seagrass has the advantage in capturing the ammonia. Consider the mass of seagrass shed in the fall seeding and winter regression. Notice the large cohort of shellfish is required to capture that organic matter on its return such that it is a net nitrogen gain for the seagrass. In this fashion the polyculture extends it influence so that surpluses of available nitrogen are reduced and our polyculture has broad influence on the dinoflagellate Prorocentrum.

The dinoflagellate, Prorocentrum minimum, was found to bloom under high loadings of nitrogen from poorly treated sewage, agricultural loading, and atmospheric deposition in Japan and the southeastern waters of the U.S. (Burkholder 1998).

But if the seaweed and seagrass is not coupled with a rate appropriate cohort of shellfish the released DOM will merely stimulate bacterioplankton and other mixotrophic dinoflagellates like Aurecococcus.

Aurecococcus Brown tide does not appear to occur in response to inorganic macronutrient loading (e.g. eutrophication; Bricelj and Lonsdale 1997). In fact, persistence of brown tide may be related to its ability to grow at very low dissolved inorganic nitrogen levels (Bricelj and Lonsdale 1997). Persistence of brown tide blooms may also be related to the ability of Aurecococcus anophagefferens cells to use both autotrophic and heterotrophic pathways to survive (Bricelj and Lonsdale 1997).

In estuaries where there is a large terrestrial influx of organic material the proportion of shellfish to sub-aquatic vegatation (SAV) would need to be higher, but never so high as to make the SAV insignificant. The sulfated polysaccharides contributed by the SAV seem to be much more effective at increasing shellfish fecies and psuedo-fecies than an equivalent amount of terrestrial humus. Without the aid of that SAV mucus the shellfish are apt to be much less efficient at capturing picoplankton. Such a refuge from grazing is bound to have an impact on the size distribution of the plankton and favor monad blooms.

Which brings us to Pfiesteria. Since Pfiesteria is strictly a predator in its toxic stage, the availability and quality of prey determines its success to a large degree. Large size prey are likely to be far apart. Small prey may be abundant but they are small. Prorocentrum minimum seems to be just about right. At least Pfiesteria have been observed moving preferentially towards Prorocentrum.

The Shellfish:SAV polyculture diminishes Pfiesteria prey in the monad and Prorocentrum size ranges.

REMEDIAL BENEFITS IN SHELLFISH:SAV POLYCULTURE: The remedial tending of the ecosystem to avoid HABs is greatly facilitated by shellfish:seagrass:macroalgae polyculture in that the economic productivity of those shellfish beds justifies strategies to restore the ascendancy of diatoms over an instance of a hazardous dynoflagelates.

A. Aeration can eliminate stratification and distribute nutrients.

B. Bloom breakup can be accomplished by propeller wash in the small embayments where some blooms begin.

C. Silicate deficiencies can be amended by working the shellfish beds, whether by preparation for planting, or harvest.

The proactive approach has much more appeal but is harder to prove.

For some reason the Chesapeake Bay is blessed with mild mannered plankton. Even the species that are notorious elsewhere do not exercise their toxic biochemical strategies here. This contrast between waters posses a question—Under what conditions do potentially toxic species tend towards significance and under what conditions will toxic strategies manifest?

It seems likely that most toxic biochemical strategies incur some biological cost. As much as that is true, if no opportunity is present to make the toxic biochemical strategy advantageous then the strategy's expression will be a comparative disadvantage and will tend to be extinguished by either self-management or competition. There are many cases were it seems that evolution is unfinished or subject to highly lagged behavior, but the pattern is still a serviceable principal when there is not specific knowledge about contrary or unfit behavior.

6) Acid Forming Sediment (Sulfide Rich) Rendered More Benign by Marl Amendment

The acid formed in the process of the common resuspension of estuarine sediments with high chemical oxygen demand, under oxic conditions, can be managed and mitigated. Frequent, small, directional, resuspensions of small impact are desirable rather than catastraphic resuspensions or randomly directed resuspensions such as will be the likely case under weather forcing. The claimed sediment resuspension foil is used for that purpose. All comparable resuspensions are less caustic if the sulfide:carbonate ratio of the sediment is more to the carbonate. The biologically endurable sediment resuspension and transit rate can be higher if the sediments iron sulfide is balanced by an appropriate amendment of calcium carbonate rich marl. The summer mature oyster mortality has been halved by marl treatment of the water.

SEDIMENT RESUSPESION FOIL AND PROCESS: (claim 17) Fine sediment with a high chemical oxygen demand is a disaster waiting to happen in oyster culture. This sediment may be managed to advantage. Redox neutral sediment may also inhibit spat set and should be managed also. This patent includes a device to resuspend sediment settling on shellfish beds and a procedure for using that device. This device is intended to enhance oyster spat set and shellfish recruitment in general and to promote the health of the bethnos in general in that the device and its use are designed to assist the divergent evolution of estuarine soils. The device is a foil on runners towed on the estuary bottom such that sediment lifting vortices are efficiently created.

This device is dragged over the submerged shellfish beds with the foil a few inches above the bottom and at a speed sufficient to create currents strong enough to resuspend the some of the fine sediment that settled on the shellfish bed.

This device is a foil, towed with its short faces roughly normal to the direction of tow, like the swept wing of a propeller driven airplane, towed from its mid-point without load spreading bridle (otherwise the device would be apt to hang on any snag), and with a sled like runners on the ends to prevent the device from diving into the sediment. The foil angle of attack (about 45 degrees) is such that it both forces the runners against the bottom and produces the large vortice turbulent flows needed to efficiently resuspend the fine sediment.

This procedure is timed with the tide so that the resuspended sediment moves to the destination it will eventually move to anyway, that being a turbitiy maximum or an anomalously deep hole.

This resuspension is also timed to coincide with instances of high oxygen saturation at the water sediment interface and low metabolic oxygen demand so that is the normal cycling between iron-hydroxide:iron-sulfide may occur in the most advantageous way possible and the bethnic community is preserved from the intense and long enduring anoxia produced by the common summertime resuspensions of sediment with high chemical oxygen demand (iron-sulfide)—such incidents have made a desert of much of the bottom of the Chesapeake Bay and its tributaries. Building a sufficient base of iron-hydroxide rich sediment is one of the key conditions needed to return to the geologically normal (Virginia) orange sediment regime.

The acid produced when iron sulfide cycles to iron hydroxide may destroy valuable oyster clutch, potentate toxins, disable c-lectin immune defenses, and generally stress estuarine life. Marl amendment to the estuarine soil will preferentially react with that acid and prevents much of the associated damage. (claim 37)

Under oxic, high CO2 conditions iron-hydroxide will compound with CO2, expand, consolidate and seal in the potentially noxious sediment for an enduring and geologically normal transition to a highly productive bethnos.

Dense seagrass and clam beds are apt to capture that resuspended iron-hydroxide and provide the sediment with a stable location where is more likely to see the combination of high partial pressures of both O2 and CO2 and become consolidated. This remains to be seen but geological evidence does support the anticipated chemistry (link). These Clam:Seagrass polyculture beds may serve in place of groins (claim 18) with great economic and ecological advantage, particularly when the area around those beds are managed to maximize shellfish production.

7) Iron sulfide and other sediment toxin sequestration by marl or sand with shellfish and seagrass armoring. There are many instances where it is best to sequester noxious and/or sulfide rich estuarine sediment under a layer of calcium carbonate rich marl so that the previously unproductive and relatively barren estuary bottom may be restored to vigorous health, biotic diversity and shellfish productivity. Prior to that amendment the resuspended sediment from that bottom created patches of “dead” water that made barren any estuary bottom it traversed while in that noxious state. The full details of this is described at http://www.sweetwater-oysters.com/o000125mrc.htm and http://sweetwater-oysters.com/o000125experiment.htm and is incorporated in this disclosure by reference. (claim 38)

8) Marsh Grass and Bottom Slope Reinforcement: It is possible to save a fringe marsh from erosion due to the increased wave action and/or bottom slope incumbent with real estate development. The marsh grass erosion face and adjacent top and bottom may be reinforced with a coarse landscaping net or clam predator exclusion net. The net is best applied in early spring and the grass to be netted burned or cut of so the net will set low and the spring shoots will form quicker and stronger. Shellfish seed should be applied also. The shellfish armors the grass roots during strong wave attack and the shellfish excreta feeds the grass. The combination is vigorous and robust—I call it “The Spartina ReefWall”. The mesh may also be used to stabilize underwater dredging scarps so that dredging may be minimized. This feature is of considerable economy and is ecologically advantageous. (claim 30) (claim 27)

9) Spartina:Oyster Reef and Mitigation: (claim 11) Large quantities of moving sand on sand flats will smoother developing shellfish and seagrass beds. The sand on these flat may be stabilized by moving chunks of Spartina marsh to the flats and stabilizing the marsh with predator exlusion net. This presents an opportunity to save a whole mature community of organisms that might otherwise be lost to a marina development. Moreover many small (typically 14 foot by 50 foot) stabilized marsh islands provide much more edge zone than the original marsh and supports much more life and more diversity of life. The large area vertical relief with predator exclusion net support provides excellent habitat for oysters and mussels and mimics the “inverted eggs cartoon” reefs built by the Virginia Marine Resources Commission (VA MRC) but on a much larger possible scale and much lower cost. In that the netting will support cultchless hatchery raised oysters the building of this kind of oyster reef that is not constrained by the acute shortage of oyster cultch. The harvest from these oyster Spartina:Oyster reefs can provide much clutch for conventional reef development.

This Spartina:oyster reef strategy should find great favor with the government regulators because the whole mature spartina grass community is saved and has its per square foot ecological value enhanced plus it enhances the ecological value of the surrounding sand flat.

10) Spatina Mitigation with Oyster Reef: In an area where there a low quality wetland of relatively abundant Spartina grass is going to be destroyed by marina development the marina may be able to mitigate the wetland loss by substituting high quality oyster reef that is built right into the marina. There is cause this strategy to find great favor with the government regulators in that this is “in kind” and “in place” and of greater utility to the estuary.

11) Reef Warf & Upweller: When the riprap or waffle bulkhead is seeded with oysters it makes a respectable oyster reef. The oyster reef value may be further enhanced by using a portion of the area under the boardwalk to hold oyster trays and by creating an air driven upwelling at the doc face to ensure the productivity of the oysters with a steady supply of aerated water and plankton.

12) Canal Maintenance by Aeration and Shellfish Air driven upwellings can contribute considerable value to a canal rich real estate development. The current produced by the upwelling can scour the bottom and prevent infilling in places where that needs to be remedied. The air driven upwelling will also favor the diatom plankton over the sometimes rude dinoflagellates. The air driven upwelling can remove the zones of ‘dead’ water and enliven the canal such that it can be a net ecological enhancement to the estuary. The incumbent development of large standing stock of shellfish filter feeders makes for an unlagged increase in plankton grazing as plankton bloom. The moderated bloom will discourage stinging nettle proliferation by diminishing their food. The aeration also tangles the nettles tentacles and puts air bubbles in their bells dramatically reducing the nettles' feeding effectiveness. Singing nettles are major predators of shellfish larvae. This dynamic would tend to tend to turn the development channels into highly productive shellfish breeding areas. The anticipated pleasure of backyard fishing and wildlife observation would be realized to an extraordinary degree. This good thing is also a financial bargain. (claim 39)

13) Waffle bulkhead: Traditional bulkheads are falling out of favor in waterfront development because of their high cost, relatively short life, frailty, and high replacement cost. A modest quantity of well-placed rip-rap over strong landscaping cloth avoids the short-comings of traditional bulkhead but requires that a board walk and pier be built into the riprap when boat access is required. The cost of carefully placing the riprap around the pilings and over the landscaping cloth is fairly high. The riprap can be replaced with a waffled panel made of concrete that can provide the same benefit at lower cost. The waffle indentations pierce the panel for hydrostatic pressure equalization. The waffed panel can have a much higher surface to weight ratio making the waffle both economical in materials and environmentally superior to the riprap. Where the Waffled panel is visible and aesthetics are a consideration the waffle pattern is fractal and psuedo-random. With respect to incoming waves the waffled panels are much rougher than a comparable weight of riprap and will absorb and refract much more of the wave energy making the installation much more neighborly than a conventional man-sized riprap or bulkhead.

14) Seagrass mitigation: Seagrass mitigation must be allowed or any seed spreading seagrass restoration may be seen as a major threat to the property rights of waterfront landowners. Under those conditions shellfish farmers, who cannot afford to offend their neighbors, will not contribute to the seagrass restoration by shellfish:seagrass polyculture. Moreover If seagrass mitigation is not allowed existing inconvenient beds are apt to see so much crab dredging that they disappear. Sad, but true. History shows that brittle regulation is apt to be bypassed or broken.

15) Spartina mitigation with Seagrass: In an area where there a low quality wetland of relatively abundant Spartina grass is going to be destroyed by marina development the marina may be able to mitigate the wetland loss by substituting a high quality seagrass:shellfish:predator exclusion net bed within the same estuary. Where the seagrass is of much higher relative ecological value, there is cause this strategy to find great favor with the government regulators in that this is “in kind” and “in place” and of greater utility to the estuary.

16) Stinging nettle abatement by shellfish culture: The recreational value of estuary water would be greatly enhanced by a reduction in stinging nettle (Chrysaora) populations. Clams and oysters indirectly reduce the density of stinging nettle food and are apt to capture stinging nettle planular spawn and bury them in the shellfish psuedo-feces. Zooplankton eating fish like shad, mullet and menhaden are an aid to both Chrysaora decrease and shellfish productivity in that they eat Chrysaora food and eat competitors for shellfish food. The populations of those fish are enhanced by the shelter and diversity provided by the Spartina:Oyster Reefs, Ellgrass:Clam Polyculture beds, BUPSYs and the other cultural devices in this system. The combined increase in those fish, clams and oysters should decrease the predominance of Chrysaora and other Cnidarians. There are places in suburban estuaries where recreational values greatly out-weighs the fishery value of shad, mullet, and menhaden. Net fishing of those low price species may be advantageously prohibited, as has been done in Florida. Except on a local basis such prohibitions or moratoriums seem unlikely and politically offensive. A modest water column extension to shellfish leasing is more apt to find favor but would be modest in results.

Shrimp:Seagrass:Macroalgae:Phytoplankton:Clam:Oyster

POLYCULTURE: The assemblage of shellfish in the previously mentioned polyculture sort their captured filtrate and excrete about half as undigested psuedo-feces This presents a resource that needs to be utilized or else it will make the surface sediment suboxic and a source of high oxygen demand on resuspension. If the predator exclusion net is raised sufficiently (4 to 12 inches) the underside presents an opportunity for shrimp culture. In addition to handling the psuedo-feces issue, the shrimp will consume zooplankton that compete with the shellfish and mature into fouling organisms like tunicates. A large population of shrimp will also discourage young crabs and pistol shrimp by strong early competition. Without some form of cultural intervention the crabs and pistol shrimp could severely damage the shellfish culture. The addition of shrimp to the polyculture allows longer shellfish culture cycles and less maintenance as well as providing and additional source of short cycle income. (claim 28) Phytoplanton capture and nutrient processing efficiency can be simultaineously maximized by the use of Shrimp:Clam:Oyster polyculture where the PE net is attached to a frame that lifts the upstream edge of the top PE net frame to the allowable 12 inch height and the downstream edge is set at four inches height. The distance between the upstream edge and downstream edge is about three feet. The PE net enclosure is about 20 feet in length. The vertical faces and bottom of the PE enclosure are also covered with net. Clams are seeded before the PE enclosure is set on top of them. Shrimp are seeded within the enclosure. Oysters are seed on top of the Enclosure. The bioturbation produced by the shrimp and the current acceleration produced by the angle and orientation of the upper PE net will prevent fine sediment accumulation and smothering. An estuary location must be chosen to prevent excess sand accumulation and smothering. Solidified Seaweed Soup (3S) may be used to attract shrimp that are small enough to get through the PE net. When the shrimp grow on the 3S and the clam and oyster excretia they will not be able to get back out. Early on, it seems unlikely that natural shrimp seeding would be anymore adequate than unaided clam or oyster seeding.

SPRINKLER IRRIGATION of air exposed intertidally growing shellfish. Intertidal Shellfish culture has many advantages such as: 1) reduced disease in oysters, 2) better public access for pick/rake-your-own operations, 3) much reduced crab predation on broad intertidal flats, 4) reduced operating costs, and frequently excellent food and oxygen supply. These intertidal flats frequently are devoid of shellfish older that a year or two because the combination of low tide and extreme heat or cold results in a die-off. This mortality is largely avoided if the shellfish are protected from the extreme heat or cold by a suitable sprinkling of estuary water. (claim 24) Sprinkler irrigation of air exposed harvest ready shellfish can discourage birds and prevent the market-ready shellfish from being damaged by bird excreta.

SECURITY VIA DIGITAL CAMERA & THE INTERNET: Seeing that a large increase in the supply of shellfish will perturb the market there is a need for security against luddite interests as well as theft of the highly valuable and marketable shellfish in the nursery and Grow-out phases. The current producer price of a top neck hard clam is as much as 24 cents and profit may be made at 10 cents. Given the small acreage of cultured shellfish production, the probable feudal organization of those acres, and the $140,000 an acre difference between market top and market bottom prices there is a scary incentive for production suppressing activities. Unfortunately the crimes committed against the embodiment of this invention have not just been the VA§18.2-481(5) variety—six physical attacks occurred in the first spawning season and racketeering appears likely. Security is provided by starlight capable digital cameras in redundant panoramic array within a cylindrical housing of steel surrounded by plexiglass such that the cam viewports are not readily visible. The viewports are 40 to 50 degrees on center (according to camera field-of-view) but vary randomly with respect to elevation in the housing. This obscurity and casing gives the observation platform rifle hardening. Internal steel baffles capture any projectile penetrating a viewport. This video observation system has a controlling PC and cell phone. Either camera or connection failure will prompt an emailed alarm. Normally the photo/email process is trigger by timer and infrared triggering. These photos are promptly and automatically emailed off-sight. The internet connection is established by cell phone. The original is kept within the modestly secure housing. Most of the security is in that the record of a crime may not be stolen. Of the huge number of security related patents none have addressed the need for discrete, sparse, records of observation (on remote location) that enable economical electronic transport to the relatively secure, robust, and public internet domain.

1. I claim as my invention a shellfish nursery stock container consisting of two framed mesh sheets fastened together and sometimes spaced apart by a combination of shims (mesh, solid and/or compressible) such that the depth of the frame is adjustable to both accommodate the shellfish growth and hold the shellfish so they will not be overly jostled by high flows of water. (FIG. 3)

2. I claim as my invention a shellfish growing device (FLUPSY) with a pivoting vane used to obstruct and bind a flow of water such that it is forced up through a separate mesh frame which contains shellfish. The pivoted vane accommodates a change in the tidal flow direction. (FIG. 1)

3. I claim as my invention a shellfish growing device (FLUPSY) with the ability to work while moored in series, bow to stern. This is accomplished by having water exit on the sides above the bottom plain of the mesh shellfish container and also by an approximately upright panel perpendicular to the current to block the flow of water above the bottom plain of the mesh shellfish container at either bow or stem of the FLUPSY. This prevents the exit water of an up-current FLUPSY from pressing down upon the exit water of the next FLUPSY in the series. Descending side panels extend below the mesh shellfish container to inhibit the exit water from flowing down into the intake of next FLUPSY. (FIG. 1)

4. I claim as my invention a shellfish growing device (BUPSY) with a pivoting mesh container (not a separate vane) used to obstruct and bind a flow of water such that it is forced through the mesh frame which contains shellfish. The pivot accommodates a change in the tidal flow direction. (FIG. 2)

5. I claim as my invention a shellfish growing device, a TWWELLER (Two Way upweller/downweller) with opposing flexible scoops opening on both the up-estuary and down-estuary moored ends of the device. The shellfish are placed in a roughly horizontal mesh container between the two scoops. On the changing of the tide the scoop that was an inbound scoop becomes an outbound cowling and the flow through the mesh changes direction so the mesh and scoop/cowls will tend to clear themselves of fouling—the device oscillates between up-weller and down-weller. (FIG. 11)

6. I claim as my invention the premarket hypersaline treatment of marine products (feed ingredient products and human consumption products) to enhance the production of osmoregulator chemicals.

7. I claim as my invention a water filtering device in which small fish and crustaceans that are captured between the filter panels such that they must clean the mesh panels or starve. This device and cohort emulates the self cleaning behavior of the marsupium used in freshwater mussel reproduction. See FIG. 18

8. I claim as my invention a device, a BUPSY, consisting of a shallow mesh envelope with a length to width ratio of 3 or greater; that has an opening along one long edge, that has a strong-back and closure device bound to that opening edge. The strong-back is given floatation sufficient to buoy the assembly and the shellfish contained therein. The assembly is anchored so that it may maintain a position just off the bottom with the strong-back horizontal and normal to the usual current. See FIG. 17

9. I claim as my invention a grounding tolerant current capturing device that is able to clear itself of incoming sediment, and commonly experienced debris and vegetation. The device is scoop of flexible fabric with flexible deep and leading edges. The scoop has portions of its small end left open so that a portion of the captured water will exit the scoop in an accelerated fashion carrying the debris and sediment with it. Since the deep and leading edges of this scoop are flexible the scoop may touch bottom with much lower probability of damage and operational disruption. (FIG. 13)

10. I claim as my invention a device and process that maintains and develops water channels by means of an array of foils that direct and accentuating natural bottom scour and transport in the desired direction and inhibits scour and transport in the undesired direction. See FIG. 19

11. I claim as my invention the shellfish reef geo-structures constructed from salt marsh and netting reinforcement. See FIG. 16

12. I claim as my invention a soup made from cooked seaweeds as a nutrient and water conditioner for filter feeding shellfish and phytoplankton.

13. I claim as my invention the pre-ship “Seaweed Soup” ‘finish’ feeding of clams and oysters to ensure their table quality and guarantee that the clams or oysters are sweet tasting, fat and safer to eat raw. This finish feeding purges some natural phytoplankton can impart a bitter after taste.

14. I claim as my invention the addition of calcium to seaweed soup to increase its gel strength and solidify it so that it can be a slow release food for aquatic life that has enhanced palatability and antibacterial benefits.

15. I claim as my invention a fermented food for feeding shellfish that is made from a soup made from cooked seaweeds that is inoculated with a selection of naturally occurring probiotic bacteria. This fermented food is useful for conditioning shellfish for breeding and for market as it fattens them and quantitatively overwhelms deleterious bacteria such that they are purged and their niches occupied by the probiotic bacteria in the food. The mucus net formed by the sulfated polysaccharides from the rendered seaweed bundle the bacterial so that the shellfish may capture the bacteria and feed on them. The mucus net assisted feeding on bacteria also assists with the purging of potentially deleterious bacteria by enabling the shellfish to digest them.

16. I claim as my invention a shellfish growing device, a open top marsupium. The mesh-paneled open-top container has more area for exiting water than for entering water so that flow-thru may be sufficient to support a high density of larvae without having the larvae pinned to the exit port mesh. (See FIG. 18)

17. I claim as my invention a snag resistant device to resuspend sediment settling on shellfish beds. The device is a swept wing foil on runners towed on the estuary bottom such that sediment lifting vortices are efficiently created. The device will have no load distributing bridle so it may pivot on its tow point in order that it may better escape snags. See FIG. 14

18. I claim as my invention the process of using shellfish polyculture to provide cost effective and ecologically advantageous infrastructure benefits to marine landforms: Beaches may be enhanced by using this culture to build the beach foreshore. Shorelines and anchorages may be protected by using this culture to build protective bars and environmentally advantageous groins. See FIG. 19

19. I claim as my invention the process of using shellfish polyculture to provide a cost effective and ecologically advantageous means of channel building and/or stabilization. This is accomplished by using this culture to 1) build and stabilize marine landforms adjacent to the channel so as to enhance channel scour, 2) using BUPSY shellfish culture to increase scour and/or hydraulic roughness at strategic points, and 3) using shellfish to armor an eroding channel side or bottom.

20. I claim as my invention the porous lime (calcium carbonate, dolomite, shell hash, etc.) embedded anode used in the electrolytic pH raising (sweetening) of (acidic) water.

21. I claim as my invention the cavitation suppressing marine propeller nozzle that uses the fore and aft extension of the upper portion of the propeller nozzle or shroud to compensate for differences in hydrodynamic pressure with depth while under power. See FIG. 9

22. I claim as my invention an aquaculture breeding selection by challenge process useful in the selection of progeny with innate immune competencies that are not c-lectin dependant. The process consists of creating conditions of relative base depletion so that the calcium ion dependant c-lectin functionality will be impaired. The process places the progeny in a flow through containment in natural waters so that the progeny might be exposed to a normally wide range of potential pathogens; Naturally occurring potential pathogen carriers may be seeded in the inflowing water as well. The water flowing into that containment is locally acidified and base ion depleted by means of reversed cathodic protection. On a per challenged individual basis, it is many orders of magnitude cheaper to select by challenging recently hatched progeny than it is to select by challenging adults.

23. I claim as my invention a permanent (or disposable) mooring and aquaculture anchor with exceptionally high holding power and low weight and cost that has the general shape and function of a detachable harpoon point and is harpooned into the bottom with a wash-pipe. See FIG. 10

24. I claim as my invention the process of sprinkler irrigating intertidal shellfish when on the low tide the shellfish would be damaged by hot or cold weather or seabird excreta were it not for the moderating effect of the irrigation. This new process is particularly significant in that it markedly enhances the economics of “finishing” deepwater grown shellfish in inter-tidal locations so that shelf-life and marketability will be enhanced. This new process is also significant in enhancing the economics of using intertidal ‘hardening’ of nursery-stock shellfish so that they will resist polydora (mud worm) infestation.

25. I claim as my invention a grow-your-own clam predator exclusion net made from the roots of subaquatic vegetation that can replace the high maintenance, high smoother risk, politically vulnerable, plastic clam predator exclusion net.

26. I claim as my invention the shellfish polyculture device of using clam predator exclusion net to raise oysters on top of the net in addition to raising clams under the net.

27. I claim as my invention a process of enhanced cultivation of aquatic vegetation such as Spartina sp. And Zostera sp. by the use of shellfish polyculture to supply the vegetation with fertilizer by means of shellfish excreta.

28. I claim as my invention the crustacean:mollusc polyculture device of using clam predator exclusion net to raise crustaceans like shrimp in combination with molluscs like clams and oysters. This invention is an expansion of customary usage of clam predator exclusion net in which a single “story” clam culture is expanded to a three “story” culture with the crusetaceans penned in the middle within predator exclusion mesh and molluscs above and below the shrimp.

29. I claim as my invention a process of enhancing the cultivation of shellfish by the use of macroalgae and sub-aquatic vegetation (SAV) such as Zostera mariana to supply the shellfish with beneficial DOM, enhanced immune and shell building water chemistry, enhanced phytoplankton production and enhanced phytoplankton and bacterioplankton capture.

30. I claim as my invention the use of a horizontal mesh, like clam predator exclusion mesh, to anchor and cultivate marsh grass and a rooted sub-aquatic vegatation (SAV) such as Zostera mariana.

31 I claim as my invention panels for constructing a shellfish growing device. These shellfish culture device panels are open frames, approximating a plane, and covered with a disposable impermeable envelope. This envelope will intentionally tear in storm conditions so that further damage can be minimized. The envelope is shed to clear bio-fouling when needed.

32. I claim as my invention a floating shellfish growing device (the Spawntoon assembly) consisting of two classes of pontoon assemblies, a heavier class and a lighter class. The heavier of the pontoon assemblies may be the lifting and maintenance assembly. The lighter assembly flanks the heavier. The lighter assembly consists of a pontoon with breasting spars. One end of the spar is affixed to the light pontoon and held in breasting position. The other end of the breasting spar is attached to the heavier pontoon assembly so that the lighter pontoon assembly may bob freely on the waves. Dividing the pontoon support into these two assemblies and providing this particular flexible coupling between them is the essence of the utility in this invention claim. (FIG. 6)

33. I claim as my invention a water supported live well consisting of 1) an impermeable membrane attached to the rim which bounds the well's contents from the supporting water; and 2) a top rim, ridged enough to establish a consistent elevation of that rim (possibly with the aid of floatation in the rim), to maintain separation between the liquid contents of the well and the liquid supporting the well and supply lifting points. See FIG. 8

34. I claim as my invention a larval capture and draining device used to retain the spawn when a floating hatchery live well is drained by lifting or floatation such that the water is removed near the surface of the water containment even as that water level changes and that the larvae are captured at the inlet of the draining device rather than at the outlet as in the prior practice. This new device makes the water supported live well practical. See FIG. 8, FIG. 5

35. I claim as my invention a movable stretcher to both support a horizontal algae culture bag over a span, and to provide shade to the spanned region. See FIG. 7

36 I claim as my invention a wave agitated floating platform for the agitation and support of phytoplankton/microbiological culture. See FIG. 7

37. I claim as my invention the process of mitigating the acid formed in the inevitable process of resuspending of estuarine sediments having a high chemical oxygen demand. Frequent, small, directional, resuspensions of small impact are desirable rather than the catastropphic resuspensions or the randomly directed resuspensions that are more likely to occur in the unmanaged course of natural unless those natural events are preempted with intentional resuspension and capture. All comparable resuspensions are less caustic if the sulfide:carbonate ratio of the sediment is more to the carbonate. The biologically endurable sediment resuspension and transit rate can be higher if the sediments iron sulfide is balanced by an appropriate growth or amendment of calcium carbonate rich marl.

38. I claim as my invention the sequestration of toxic and/or sulfide rich estuarine sediment under a layer of marl or limonite so that previously unproductive and relatively barren estuary bottom may be restored to vigorous health, biotic diversity and shellfish productivity.

39. I claim as my invention a new use and a ‘Best Practice’ process in the development and management of low flow estuarine canals in a water front real estate development where the liveliness and productivity of the channel is promoted, sedimentation is locally eliminated, stinging nettles are suppressed, phytoplankton diversity enhanced and hazardous dynoflagelate blooms suppressed and the canal turned into a highly productive area for shellfish reproduction. This process is effected by the release of air bubbles from the bottom of the channel such that it creates a continual upwelling and current.
